(19) United States
(12) Patent Application Publication
(10) Pub. No.: US 2017/0061091 A1
(43) Pub. Date: Mar. 2, 2017

(54) Indication of Outreach Options for Healthcare Facility to Facilitate Patient Actions

(71) Applicant: Uptake Technologies, Inc., Chicago, IL (US)

(72) Inventors: Adam McElhinney, Chicago, IL (US); Alexander Gutfraind, Chicago, IL (US); Nelson Bowers, Chicago, IL (US)

(21) Appl. No.: 14/836,652

(22) Filed: Aug. 26, 2015

(51) Int. Cl. G06F 19/00

(52) U.S. Cl. CPC G06F 19/3418; G06F 19/322; G06F 19/3431

(57) ABSTRACT

Disclosed herein are systems, devices, and methods related to patient response to outreach options of healthcare facilities. Examples involve determining patient response metrics for patients based on patient data and/or other data. A patient response metric indicates a probability that a patient will perform a medically-related patient action in response to an outreach option. Example output data can indicate various outreach options, patient response metrics for outreach options, expected value of implementing outreach options, and/or recommendations of outreach options.

### BACKGROUND

Healthcare facilities provide a variety of medically-related services to patients, including diagnosis and treatment of patient health issues, pharmaceutical services (e.g., medical prescriptions), and ongoing treatment (e.g., medical checkups, periodic administering of medication, physical therapy, etc.). Many of the medically-related services require patients to take actions such as visiting a healthcare facility or related organization, signing up for prescriptions, responding to inquiries, etc. However, patients may not take the actions required to pursue medical services, e.g., they may procrastinate, delay, avoid taking action due to financial reasons, etc. In some cases, this may be detrimental to the patient's health. Also, patients failing to follow up on required medical services may impact revenue received by a healthcare facility. Healthcare facilities may spend resources to perform outreach tasks to encourage patients to maintain their care, with varying levels of success.

### SUMMARY

Implementations generally relate to indication and/or optimization of outreach options for a healthcare facility to facilitate patient actions. In some implementations, a computing system includes at least one processor, a non-transitory computer-readable medium coupled to the processor, and program instructions stored on the medium that are executable by the processor. The instructions cause the computing system to identify a plurality of outreach options for causing a target patient to take a medically-related action. The instructions cause the computing system to determine, based on patient data, a patient response metric for each of the plurality of outreach options for the medically-related patient action, where a patient response metric for a given outreach option indicates whether (e.g., a probability) the patient is likely to perform the medically-related patient action in response to the given outreach option. The instructions cause the computing system to generate output data based on the patient response metrics for the plurality of outreach options, and to transmit the output data to an output device, where the output data facilitates display, by the output device, of a representation of at least one of the outreach options.

In some implementations of the computing system, the instructions of the computing system may further cause the computing system to determine a prioritization for one or more of the outreach options based on the patient response metrics, where the output data can facilitate causing the output device to display a representation of the prioritization.

The instructions may further cause the computing system to facilitate the automatic execution of at least one outreach option from the plurality of outreach options. For example, the computing system may trigger an electronic message to be sent the target patient, a call to be placed to the target patient, a letter to be generated and sent to the target patient via physical mail, and/or a visit to the target patient to be scheduled.

In some implementations of the computing system, the instructions can cause the computing system to determine an expected value for each of the plurality of outreach options based on the patient response metrics and one or more estimated valuations assigned to the medically-related patient action. The generation of output data can be based on at least one of the expected values. For example, the instructions can cause the computing system to determine a baseline patient response metric associated with each of the patient response metrics based on the patient data, where the baseline patient response metric indicates whether the patient is likely to perform the medically-related patient action in absence of the outreach option. Each expected value can be adjusted based on the corresponding baseline patient response metric. In some examples, estimated valuations can be based on a current health indicator or future health indicator indicative of a current or future health of the target patient, one or more measures of a current quality of life and a predicted future quality of life of the target patient, one or more costs to implement the medically-related patient action, and/or the outreach costs to implement one or more of the outreach options.

In some implementations of the computing system, a first outreach option includes a first individual outreach effort and not a second individual outreach effort, and a second outreach option includes both the first and second individual outreach efforts. In some implementations, the medically-related patient action can be one of a plurality of identified medically-related patient actions and the plurality of outreach options can include one or more outreach options associated with each of the plurality identified medically-related actions, and the determination of patient response metrics can include determination of the patient response metric for each of one or more combinations of one of the identified medically-related patient actions and one or more of the outreach options.

In some implementations of the computing system, the patient data can include a variety of types. For example, patent data can include data describing a financial history of the target patient and the patient response metrics can be determined additionally based on the financial history. The patient data can include data describing a transaction history of the target patient with respect to the healthcare facility, and the patient response metrics can be determined additionally based on the transaction history. The patient data can include location data describing a geographic home location of the patient and distances from the geographic home location to one or more geographic locations of the healthcare facility, and the patient response metrics can be determined additionally based on the location data. The patient data can include location history data describing a history of geographic locations visited by the target patient and a time and frequency of visits to the geographic locations by the target patient, and the patient response metrics can be determined additionally based on the location history data.

In some implementations of the computing system, the patient response metrics can be determined based on one or more prediction models of patient response. The one or more prediction models can be based on historical data describing prior outreach options previously implemented by the healthcare facility and prior patient responses by at least one patient of the healthcare facility to the prior outreach options. In some implementations, the historical data can also include other types of data to correlate the prior outreach options to the prior patient responses.

The identified medically-related patient action for the target patient may take various forms, examples of which can include the target patient visiting a healthcare facility, obtaining items of a medical prescription (e.g., by visiting a physical location visited by the target patient), enlisting in a plan that reminds the target patient of medical treatment to receive, and/or enlisting in a plan that sends one or more items of a medical prescription to the target patient.

In some implementations, a non-transitory computer readable medium has instructions stored thereon that are executable to cause a computing system to perform operations in one or more implementations similar to implementations described above for the computing system.

In some implementations, a computer-implemented method includes operations in one or more implementations similar to implementations described above for the computing system.

### BRIEF DESCRIPTION OF THE DRAWINGS

FIG. 1 depicts an example healthcare network configuration in which example implementations may be implemented.

FIG. 2 depicts a simplified block diagram of an example client device of a facility system.

FIG. 3 depicts a simplified block diagram of an example analytics system.

FIG. 4 depicts a flow diagram of an example method determining one or more predictive models for use in determining patient response metrics, according to some implementations.

FIG. 5 depicts a flow diagram of an example method to provide output indicative of predicted response of a target patient to outreach options, according to some implementations.

FIG. 6 depicts a flow diagram of a method including example blocks to perform operations of the method of FIG. 5, in which an expected value of an outreach option is determined.

FIG. 7 depicts an example graphical user interface showing a representation of output provided by one or more features described herein.

### DETAILED DESCRIPTION

The following disclosure makes reference to the accompanying figures and several exemplary scenarios. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

Healthcare facilities provide a variety of medically-related services to patients. Many of the services require patients to take actions, e.g., visit a healthcare facility or related organization, sign up for prescriptions, respond to inquiries, etc. However, many patients may not take the actions required to pursue medical services, e.g., they may procrastinate, delay, avoid taking action due to financial reasons, etc. In many cases, this may be detrimental to the patient's health. In some cases, this may also be disruptive to revenue received by a healthcare facility. For example, a healthcare facility's revenue may depend on performing procedures on patients at the healthcare facility or may depend on providing ongoing care that keeps a patient healthy.

Healthcare facilities may spend resources to perform outreach efforts or tasks to encourage patients to take actions to maintain their health care, with varying levels of success. Some approaches for performing outreach efforts for patients generally involve a healthcare facility performing standard outreach efforts for every patient. For example, a healthcare facility may have a standard procedure of placing a reminder call or sending a remainder email to a patient to remind the patient of an upcoming doctor's appointment. The facility may have a standard procedure of sending a patient a regular request to refill a prescription, via physical mail or email. Users (e.g., healthcare facility personnel) may check up on the progress of the patient or can be informed via computing systems or other devices of the compliance or non-compliance of the patient in performing particular actions.

Current outreach efforts may be inflexible. For example, the same outreach effort may be performed for each patient, yet patients may respond differently to those outreach efforts. This can lead to successful patient actions by some patients and lack of action by other patients. Failures of patients to successfully respond to outreach efforts can have a detrimental effect on the health of the patient. For example, if a patient does not go to a scheduled doctor's appointment or does not receive prescribed medication it can directly impact their health.

Due to the simplistic nature of outreach efforts, current approaches may produce results that are inefficient for patients and/or for healthcare facilities, e.g., requiring greater costs for patients and/or for healthcare facilities.

The example systems, devices, and methods disclosed herein may help address one or more of these issues. In some examples, a healthcare network configuration may include a communication network that facilitates communications between one or more facility systems, an analytics system, one or more patient systems, and one or more data sources. One or more facility systems may be configured to receive input from users such as healthcare facility personnel to request output by a healthcare computing system related to outreach options implemented by the healthcare facility, other facility, or a system. For example, in some cases, the requested output from the healthcare computing system can be related to whether a particular patient is likely to perform a medically-related patient action in response to particular outreach options. In some cases, the requested output can include the expected value of the healthcare facility performing outreach options.

In some implementations, an analytics system can be used in determining patient response metrics, expected values, and recommendations related to outreach options. For example, the analytics system may use one or more prediction models to determine patient response metrics. Prediction models can be built based on a variety of data, including historical patient data for a number of patients, e.g., historical health profile data for patients, a history of prior actions taken by patients, a history of prior outreach options implemented by the healthcare facility for patients, a history of patient responses to prior outreach options, etc. The historical patient data can also include transaction data indicating a history of financial transactions occurring between patients and healthcare facilities. The utilized data can also include external patient data obtained from sources external to the healthcare facility, such as financial data of patients and location data indicating the patient geographical locations relative to healthcare facility locations.

The analytics system may be configured to determine patient response metrics for a particular target patient. A patient response metric can indicate whether the target patient is likely to perform an identified medically-related patient action in response to implementation of a particular outreach option, e.g., by the healthcare facility or a system. A patient response metric can be determined for each outreach option that the healthcare facility may wish to implement. Patient response metrics can also be determined based on different patient actions.

In some cases, the analytics system may determine a patient response metric for each of multiple outreach options by applying a prediction model for predicting patient responses to an identified outreach option. The system applies the prediction model using target patient data to determine a patient response metric for the target patient responding to the identified outreach option.

The analytics system can also be configured to determine an expected value of each outreach option. For example, an expected value can be based on the patient response metric and estimated valuations of the patient action and the associated outreach option. For example, estimated valuations can be based on monetary costs related to a patient action (e.g., costs to provide health care treatment in response to the patient action), and/or based on the cost of implementing the outreach option. In some cases, estimated valuations can be based on measures of patient health and well-being, which may result from outreach options and patient actions. For example, an estimated valuation can be combined with a patient response metric to determine the expected value of a corresponding outreach option.

The analytics system can provide output data for output by one or more output devices based on the patient response metrics. The output data can be related to one or more outreach options. For example, the output data can indicate different possible outreach options and/or expected values for the outreach options. In some cases, the output data can indicate a recommendation of one or more outreach options for the healthcare facility to implement, e.g., based on a ranking of patient response metrics and/or expected values of outreach options. A graphical user interface can provide display output based on the output data and allow a user (e.g., a healthcare facility case manager) to view additional output and/or modify output. In some implementations, the analytics system (or other system) can instruct that at least one outreach option be automatically implemented (e.g., without human intervention) based on the patient response metrics and/or other determinations.

The described features allow a healthcare facility computing system to output a variety of indications of patient response to healthcare facility outreach efforts, including predicted patient responses and expected value of performing outreach efforts. Output information can provide predictions and estimations of a particular patient's behavior based on past patient behavior to similar outreach efforts. Healthcare personnel such as managers can use the information to plan and budget outreach efforts based on such predictions. Further, healthcare personnel can vary the outreach efforts for each individual patient to obtain higher efficiency in health benefits for each patient and efficiency in costs to the patient and/or healthcare facility. The described recommendations can provide indications of outreach efforts that have a high probability of causing a patient to perform medically-related actions associated with the healthcare facility. The recommendations can increase the success rate of patients improving or maintaining their health and can reduce or eliminate ineffectual and costly outreach efforts having little chance of motivating a patient to obtain treatment. Further, systems providing automatic implementation of outreach efforts as described herein can save healthcare facilities the time and cost of instructing or performing these efforts manually with healthcare personnel.

### Example Network Configuration and Systems

As referred to herein, a healthcare facility can refer to any organization, group of organizations, chain of suppliers, and/or other connected businesses or operations that are related to providing health care to patients. In some implementations, a healthcare facility can have one or more physical locations, e.g., at which various described systems (such as facility systems, analytics systems, data storage, etc.) can be located. In various examples, a hospital to which a patient physically travels to obtain medical treatment can be a healthcare facility or part of a healthcare facility. Clinics, specialists, associated businesses, and other related providers can also be considered a healthcare facility, or a part of a healthcare facility. A drugstore at which a patient obtains medical supplies to fulfill a prescription can be considered part of a healthcare facility.

As referred to herein, a patient is a person who receives healthcare treatment from a healthcare facility. For example, the healthcare treatment can include medically-related treatment or advice by seeing doctors, nurses, or other medical experts working at or associated with the healthcare facility, receiving scans or treatment by medical equipment, receiving prescriptions of medical items from the healthcare facility, etc. Healthcare facility personnel or facility user refers to persons involved with operating the healthcare facility and/or offering healthcare services, including a doctor, nurse, healthcare administrator, manager of a hospital department, healthcare worker, healthcare employee, healthcare agent, or other non-patient person associated with a healthcare facility.

As referred to herein, a medically-related patient action is an action that is to be performed by a patient to further a medically-related goal of the patient. For example, a patient action can include a visiting the healthcare facility or a different healthcare facility (e.g., to see particular healthcare personnel, for treatment, etc.). A patient action can include obtaining items (e.g., medicine) of a medical prescription at a physical location. A patient action can include enrolling in a plan that reminds the patient of medical treatment to receive. A patient action can include enrolling in a plan to receive treatment or supplies, e.g., a plan that sends one or more items of a medical prescription to the patient via physical mail or delivery service. The medically-related goal can be instructed, supervised by, and/or otherwise associated with the healthcare facility. The medically-related goal can be any goal defined by the healthcare facility and/or patient. For example, the medically-related goal can be defined broadly, such as to improve the health of the patient. More specific medically-related goals may be defined, e.g., reduce back pain of a patient by a certain amount, reduce the weight of a patient by a certain amount, increase walking distance of a patient, etc.

As referred to herein, an outreach option attempts to cause or facilitate a patient to perform an associated medically-related patient action. In various implementations, one or more outreach options can be implemented by the healthcare facility, and/or one or more outreach options can be implemented by other organizations or systems. For example, in some implementations an outreach option may be performed automatically by an analytics system 104 or other computing system that is not owned or operated by the healthcare facility. An outreach option can take the form of a single outreach effort or task, or multiple outreach efforts or tasks (e.g., a sequence of efforts or tasks in some cases). In some implementations, an outreach option provides communication with a patient and, for example, can attempt to motivate or otherwise cause the patient to perform the associated patient action to obtain medical treatment from the healthcare facility in some form. Outreach options, as described herein, generally do not directly provide medical advice or treatment to the target patient, but, for example, may enable such advice or treatment to occur in response to patient performance of the associated patient action.

In various examples, outreach options can include sending a reminder to a patient to visit a healthcare facility location, to enroll in a plan or program (e.g. a prescription delivery service), or to respond to a questionnaire sent to the patient, e.g., by the healthcare facility. In some examples, the outreach options can include sending an email, text message, or other electronic message to a patient, placing a call to a patient for a real-time call (e.g., a voice call over a phone), generating and/or sending a letter to a patient via physical mail, and/or sending healthcare facility personnel to visit a patient at a particular geographical location. In some implementations, the outreach options can include triggering any of these efforts.

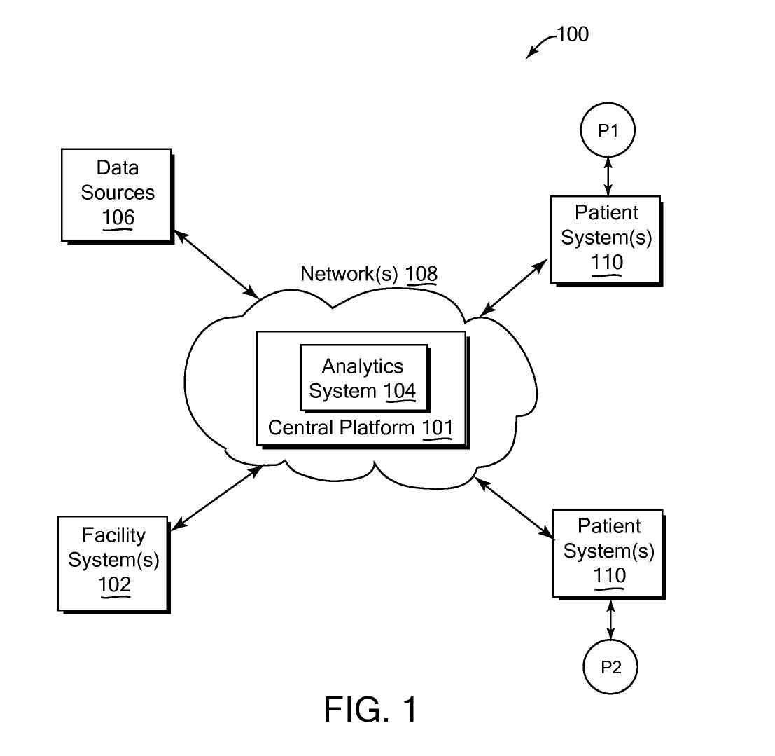

FIG. 1 depicts an example healthcare network configuration 100 in which example features may be implemented. As shown, the healthcare network configuration 100 includes one or more facility systems 102, a computing system 104 that may be an analytics system, one or more data sources 106, a communication network 108, and one or more patient systems 110. In some implementations, analytics system 104 can be included in a central platform 101 that may include other systems and communicates with the facility systems 102, the data sources 106, and other systems via the network 108. In some implementations, the facility system 102 can serve as a data source.

The communication network 108 may communicatively connect each of the components in the network configuration 100. For example, the facility system(s) 102 may communicate with the central platform 101, analytics system 104 and the data sources 106 via the communication network 108. In some cases, the facility system(s) 102 may communicate with one or more intermediary systems, such as a server (not pictured), that in turn communicates with the analytics system 104. Likewise, the central platform 101 and/or analytics system 104 may communicate with the data sources 106 and the patient systems 110 via the communication network 108. In some cases, the central platform 101 and/or analytics system 104 may communicate with one or more intermediary systems, such as a host server (not pictured), that in turn communicates with the facility systems 102 and/or patient systems 110. Many other configurations are also possible.

In general, a facility system 102 may take the form of a computing system or device configured to receive input, process data, and provide output for use by a healthcare facility and healthcare facility personnel. In some implementations, the facility system 102 can receive data input from healthcare personnel (e.g., doctors, nurses, etc.) regarding patients, store that data in electronic patient records in data storage of the facility system 102, and can output that data to the central platform 101 and analytics system 104. A facility system 102 may take various forms. Examples of facility systems include a single or network of multiple connected desktop computers, storage devices, tablets, smartphones, laptop computers, other mobile computing devices, smart TVs, wearable devices, and the like. In one example, one or more of the facility systems 102 may be or include one or more input devices configured to receive data and one or more output devices configured to provide audible, visual, and/or tactile output in response to the data. In general, an input device may include one or more input interfaces configured to receive user input, and can include a keyboard, microphone, pointing device (mouse, trackball, etc.), camera, sensors, etc. An output device may be configured to provide output to a user and/or to transmit data through the communication network 108 based on such user input, and can include a display device (display screen, projector, goggles, etc.), printing device, haptic output device, etc. In some examples, a facility system can provide an interface for facility personnel to input data and receive output from the system. In some implementations, a facility system can receive input from a user to instruct processing of other systems (e.g., analytics system 104) and/or instruct output to other systems (e.g., one or more patient systems 110).

In some examples, one or more facility systems 102 can be or include an outreach system configured to receive input such as requests from healthcare facility personnel to provide output related to outreach options as determined by features described herein. For example, the outreach system can output (or send to another device to output) indications of patient response to outreach options and recommended outreach options for the healthcare facility to implement. In some implementations, a facility system 102 can include or take the form of an outreach system that includes an outreach performance system that can automatically initiate and/or perform outreach options for the healthcare facility. In some implementations, some facility systems can include or take the form of medical devices, e.g., medical imaging equipment, surgical equipment, medical monitoring systems, medical laboratory equipment, etc. which can, for example, provide patient data describing patient health statuses, characteristics, or profiles to data sources 106 or facility systems 102. Those of ordinary skill in the art will appreciate that these are but a few examples of facility systems and that numerous others are possible and contemplated herein.

As shown, facility system(s) 102 and/or data sources 106 may communicate with the analytics system 104 via the communication network 108. In general, the communication network 108 may include one or more computing systems and network infrastructure configured to facilitate transferring data between network components. The communication network 108 may be or may include one or more Wide-Area Networks (WANs) and/or Local-Area Networks (LANs), which may be wired and/or wireless. In some examples, the communication network 108 may include one or more cellular networks and/or the Internet, among other networks. The communication network 108 may operate according to one or more communication protocols, such as HTTP, TCP, WiFi, Bluetooth, LTE, CDMA, WiMax, and the like. Although the communication network 108 is shown as a single network, it should be understood that the communication network 108 may include multiple, distinct networks that are themselves communicatively linked. The communication network 108 can take other forms as well.

The analytics system 104 may be configured to receive data from the facility system(s) 102, the data sources 106, and the patient system(s) 110. The analytics system 104 may include one or more computing systems, such as servers, databases, and/or other devices, configured to receive, process, analyze, and output data. For example, the analytics system 104 may be configured according to a given dataflow technology, such as .NET or Nifi, among other examples. For example, the analytics system 104 can determine prediction models, patient response metrics, expected value, and other features or output as described herein. In some implementations, facility systems 102 can determine or output some of these features.

As shown, the central platform 101 may include analytics system 104 among other systems (e.g., input/output systems, computing systems, etc.) communicatively coupled to each other. The central platform 101 can be configured to transmit data to the facility system(s) 102, one or more of the data sources 106, and/or to the patient systems 110. The data transmitted to the facility system(s) 102 may take various forms and will be described in further detail below. In some alternate implementations, an analytics system 104 can be included in or part of one or more facility systems 102, e.g., as a processing component of a facility system 102.

In general, a patient system 110 may take the form of a computing system or device configured to receive data and provide a form of output. For example, in some implementations a patient system 110 can be a device used by a patient to receive and/or respond to communications from the healthcare facility and/or communicate with healthcare personnel via one or more facility systems 102. The patient system 110 may take various forms. In one example, similar to facility systems 102, one or more of the patient systems 110 may be or include an output device configured to receive data and provide an audible, visual, and/or tactile output in response to the data. In general, the patient systems 110 may include one or more input interfaces configured to receive user input, and to transmit data through the communication network 108 based on such user input. Examples of patient systems include tablets, smartphones, laptop computers, wearable computing devices, other mobile computing devices, desktop computers, smart TVs, and the like. Other examples of patient systems include dedicated medical devices that can provide current patient data, e.g., pacemakers, insulin measurements, heart rate monitors, pedometers, activity monitors, digestive monitors, wearable monitors, head mounted display monitors, activity monitors integrated with mobile devices, etc. Some wearable devices may continuously collect physiological signals such as heart rate, respiration rate, oxymetry, blood pressure and other signals indicative of health for use as personal health data.

In some implementations, the output resulting from outreach options performed by the healthcare facility can be displayed on patient systems 110 associated with particular patients, e.g., messages, reminders, offers to enroll in plans, etc. In some implementations, a patient system 110 may take the form of a health-related device that can receive input from a healthcare system 102. For example, an exercise machine (e.g., exercise bicycle, weights, etc.), medicine-dosing machine, health-monitoring machine, etc. can receive commands from a facility system to provide outreach option output for an outreach option selected for implementation by a facility system 102 or analytics system 104. Numerous other patient systems 110 are also possible.

The one or more data sources 106 may be configured to communicate with the analytics system 104 and/or other systems, e.g., one or more facility system(s) 102. In general, a data source 106 may be or include one or more computing systems configured to collect, store, and/or provide to other systems, such as the central platform 101/analytics system 104, data that may be relevant to the functions performed by the other systems. Some of the data sources 106 may be configured to generate and/or obtain data related to the operation of the healthcare facility, including patient data such as historical patient actions and outreach options, patient financial data related to the healthcare facility, prescriptions and health profiles of patients, etc.

Examples of data sources 106 can include facility data sources, external data sources, and other data sources. In general, facility data sources provide data indicating or describing patient data or healthcare facility operating data related to the healthcare facility. For example, facility data sources can be implemented on one or more servers which facility systems 102 and central platform 101 are able to securely access over network 108. In some implementations, one or more facility data servers can be provided physically at a healthcare facility. Examples of facility data can include facility operating data e.g., costs of services and medical supplies, outreach options generally performed and currently in use by the healthcare facility (and their costs), other operating costs and procedures. Facility data can also include patient data relating to particular patients of the healthcare facility e.g., current patient data (e.g., health profile data), and historical patient data (e.g., historical patient actions related to the healthcare facility, outreach options performed for patients and corresponding patient responses, etc., patient financial history with respect to charges, payments, etc. for the healthcare facility, etc.).

A portion of the data sources 106 may be external data sources configured to store, generate and/or obtain data externally and independently from the healthcare facility associated with the facility systems 102. For example, external patient data stored on such external data sources 106 may not be directly related to health care, such as socioeconomic data (e.g., employment data, financial data, etc.) and geographic location information related to a patient. The data sources 106 may be configured to provide current data and/or historical data. In some implementations, the central platform 101 or a facility system 102 may receive data from a data source 106 providing external data by “subscribing” to a service provided by the data source. Some examples of external data sources can include financial institution and organization servers providing personal financial data for patients (e.g., credit history and rating, loan history, employment information) and servers and services providing geographic location data (e.g., global navigation satellite systems (GNSS) servers, map-data servers, topography-data servers that provide information regarding natural and artificial features of a given area, etc.).

One of ordinary skill in the art will appreciate that these are but a few examples of data sources and that numerous others are possible.

Network configuration 100 is one example of a network in which implementations described herein may be implemented. Numerous other arrangements are possible and contemplated herein. For instance, other network configurations may include additional components not pictured and/or more or less of the pictured components.

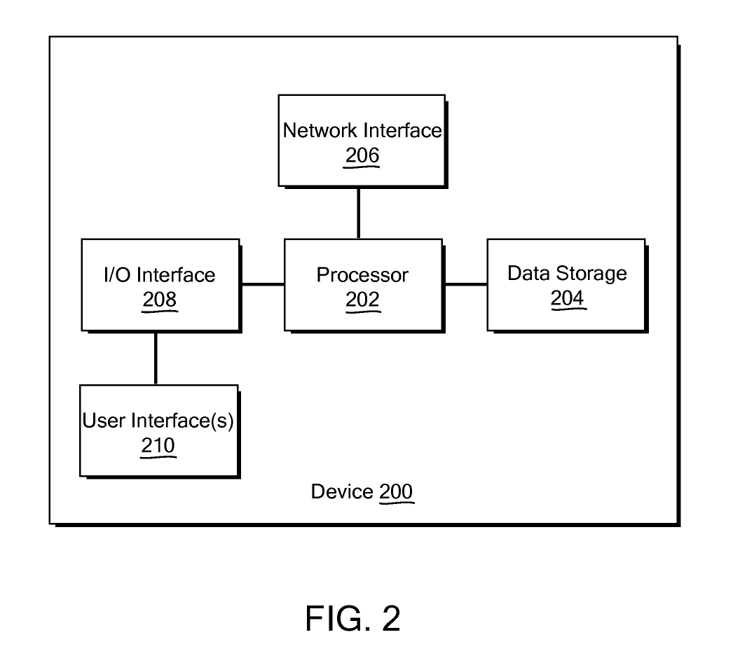

FIG. 2 depicts a simplified block diagram of an example client device 200. For example, the client device 200 may be included in one or more of the facility systems 102 of FIG. 1, e.g., used by personnel of a healthcare facility. As shown, the client device 200 may include one or more processors 202, data storage 204, one or more network interfaces 206, one or more I/O interfaces 208, and one or more user interfaces 210, all of which may be communicatively linked by a system bus, network, or other connection mechanism. One of ordinary skill in the art will appreciate that the client device 200 may include additional components not shown and/or more or less of the depicted components.

Client device 200 may include one or more electrical, mechanical, and/or electromechanical components configured to perform one or more operations.

Processor block 202 may include one or more processors, which may take the form of a general- or special-purpose processor. Examples of processors may include microprocessors, application specific integrated circuits, digital signal processors, and the like. Data storage 204 may be or include one or more non-transitory computer-readable storage media, such as optical, magnetic, organic, flash memory, magnetic tape, a removable computer diskette, a random access memory (RAM), a read-only memory (ROM), flash memory, a rigid magnetic disk, an optical disk, a solid-state memory drive, etc.

Processor 202 may be configured to store, access, and execute computer-readable program instructions stored in the data storage 204 to perform the operations of the client device 200 described herein. For example, the processing unit 202 may be configured to provide instructions to control one or more output devices of the client device to provide output, e.g., control the display of data received from an analytics system 104 and indicate, for example, patient actions, outreach options, patient response metrics, expected value, and other related data as described herein. The processor 202 may be configured to receive input from one or more input devices, the network interfaces 206, I/O interfaces 208, and/or the user interfaces 210 and based on such signals, perform operations and/or cause output from the output devices. Other functionalities of the processor 202 are discussed below.

In some implementations, data storage 204 can store additional data, e.g., electronic patient records that describe various patient data, healthcare facility operating data, and/or other data described herein.

The one or more network interfaces 206 may be configured to provide for communication between the client device 200 and various network components connected to communication network 108. For example, at least one network interface 206 may be configured to facilitate wired or wireless communications to and from the communication network 108. For example, wireless communication components may thus take the form of an antenna structure and associated equipment for transmitting and receiving various wireless, over-the-air signals. Other examples are possible as well. In practice, the one or more network interfaces 206 may be configured according to a communication protocol, such as any of those described above.

The one or more I/O interfaces 208 may be configured to interface with input devices, output devices, and other components of the client device 200 or other systems. I/O interfaces can include various electronic and mechanical components to enable interfacing with various devices. For example, input devices as described herein can communicate with the processor 202 and data storage 204 via I/O interfaces, and the processor 202 and/or data storage 204 can communicate with output devices (e.g., display device, printing device, etc.) via I/O interfaces 208.

The one or more user interfaces 210 may be configured to facilitate user interaction with the client device 200 and may also be configured to facilitate causing the client device 200 to perform an operation in response to user interaction. User interfaces can be coupled to I/O interfaces 208 in some implementations. Examples of user interfaces 210 include touch-sensitive interfaces, mechanical interfaces (e.g., levers, buttons, wheels, dials, keyboards, etc.), and other input interfaces (e.g., microphones), among other examples. In some cases, the one or more user interfaces 210 may include or provide connectivity to output components, such as display devices (display screens, projectors, etc.), speakers, headphone jacks, and the like.

One of ordinary skill in the art will appreciate that the client device 200 shown in FIG. 2 is but one example of a simplified representation of a client device and that numerous others are also possible.

In some implementations of healthcare network configuration 100, one or more patient systems 110 can include similar components to the client device, e.g., one or more processors, network interfaces, data storage, user interfaces, input and output devices, etc.

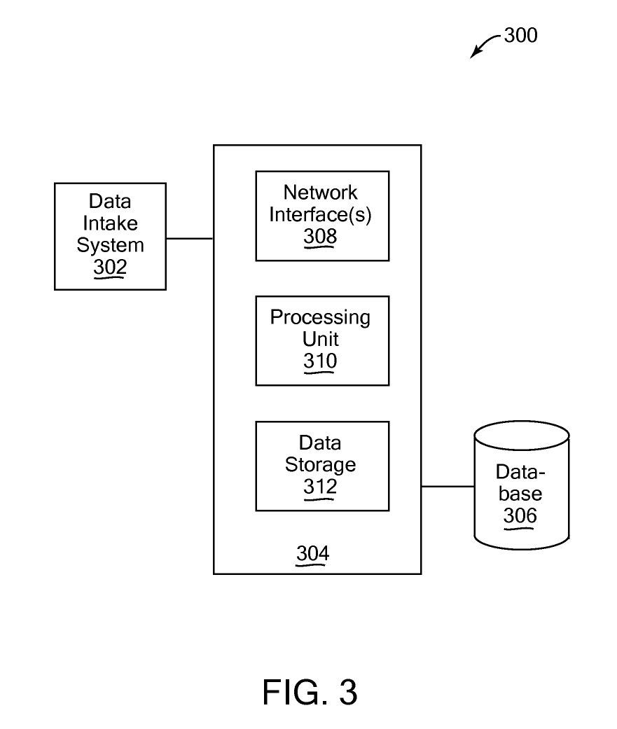

FIG. 3 depicts a simplified block diagram of an example analytics system 300. As suggested above, the analytics system 300 may include one or more computing systems communicatively linked and arranged to carry out various operations described herein. Specifically, as shown, the analytics system 300 may include a data intake system 302, a data science system 304, and one or more databases 306. These system components may be communicatively coupled via one or more wireless and/or wired connections.

The data intake system 302 may generally function to receive and process data and output data to the data science system 304. As such, the data intake system 302 may include one or more network interfaces configured to receive data from various network components of the network configuration 100, such as a number of different facility systems 102 and/or data sources 106. For example, data received can include patient data (including external patient data) and/or facility operating data. In some implementations, the data intake system can receive data from patient systems 110 (e.g., with patient permission), e.g., patient data describing patient responses or other statuses of patients. The data intake system 302 may be configured to receive analog signals, data streams, and/or network packets, among other examples. As such, the network interfaces may include one or more wired network interfaces, such as a port or the like, and/or wireless network interfaces, similar to those described above. In some examples, the data intake system 302 may be or include components configured according to a given dataflow technology, such as an Apache™ Nifi receiver or the like.

The data intake system 302 may include one or more processing components configured to perform one or more operations. Example operations can include compression and/or decompression, encryption and/or de-encryption, analog-to-digital and/or digital-to-analog conversion, filtration, and amplification, among other operations. Moreover, the data intake system 302 may be configured to parse, sort, organize, and/or route data, based on data type and/or characteristics of the data. In some examples, the data intake system 302 may be configured to format, package, and/or route data based on one or more characteristics or operating parameters of the data science system 304.

The received data may include certain characteristics, such as a source identifier and a timestamp (e.g., a date and/or time at which the information was obtained). In some cases, a characteristic can include the location (e.g., GPS coordinates) at which the information was obtained. Data characteristics may come in the form of metadata or other descriptive data, among other examples.

The data science system 304 may generally function to receive (e.g., from the data intake system 302) and analyze data, and based on such analysis, cause one or more operations to occur. As such, the data science system 304 may include one or more network interfaces 308, a processing unit 310, and data storage 312, all of which may be communicatively linked by a system bus, network, or other connection mechanism. In some cases, the data science system 304 may be configured to store and/or access one or more application program interfaces (APIs) that facilitate carrying out some of the functionality disclosed herein.

The network interfaces 308 may be the same or similar to any network interface described above. In practice, the network interfaces 308 may facilitate communication between the data science system 304 and various other entities, such as the data intake system 302, the databases 306, facility systems 102, patient systems 110, other systems of the central platform 101, etc.

The processing unit 310 may include one or more processors, such as any of the processors described above. In turn, the data storage 312 may be or include one or more non-transitory computer-readable storage media, such as any of the examples provided above. The processing unit 310 may be configured to store, access, and execute computer-readable program instructions stored in the data storage 312 to perform the operations of an analytics system described herein.

In general, the processing unit 310 may be configured to perform analytics on data received from the data intake system 302. To that end, the processing unit 310 may be configured to execute one or more modules, which may each take the form of one or more sets of program instructions that are stored in data storage. The modules may be configured to facilitate causing an outcome to occur based on the execution of the respective program instructions. An example outcome from a given module may include outputting data into another module, updating the program instructions of the given module and/or of another module, and outputting data to a network interface 308 for transmission to one or more facility systems 102, among other examples.

The databases 306 may generally function to receive (e.g., from the data science system 304) and store data. As such, each database 306 may include one or more non-transitory computer readable storage media, such as any of the examples provided above. In practice, the databases 306 may be separate from or integrated with the data storage 312.

The databases 306 may be configured to store numerous types of data, some of which is discussed herein. In practice, some of the data stored in the databases 306 may include a timestamp indicating a date and time at which the data was generated or added to the database. Moreover, data may be stored in a number of manners in the databases 306. For instance, data may be stored in time sequence, in a tabular manner, and/or organized based on data source type (e.g., based on external data, facility patient history data, etc.), among other examples.

### Example Data and Operations

The data and operations of the example network configuration 100 depicted in FIG. 1 will now be discussed in further detail below. To help describe some of these operations, flow diagrams may be referenced to describe methods, e.g., combinations of operations that may be performed. In some cases, each block of a method may represent a module or portion of program code (or multiple modules or portions) that includes instructions that are executable by a processor to implement specific logical functions or steps in a process. The program code may be stored on any type of computer-readable medium, such as non-transitory computer readable media. In other cases, each block may represent circuitry that is wired to perform specific logical functions or steps in a process. Moreover, the blocks shown in the flow diagrams may be rearranged into different orders, combined into fewer blocks, separated into additional blocks, and/or removed based upon the particular implementation. In various implementations, one or more blocks of a flow diagram may be performed at different times, simultaneously, or partially simultaneously. In some implementations, one or more blocks or operations can be implemented in hardware (logic gates, etc.), or in a combination of hardware and software.

In some implementations, the data science system 304 may be configured to determine a patient response metric for a patient, which can be a single, aggregated metric that indicates whether a patient is likely to (e.g., will) perform a medically-related action in response to implementation of an outreach option. For example, in various implementations, a patient response metric may indicate a probability that the patient will perform a medically-related action in response to implementation of an outreach option. In some cases, the metric may indicate a probability that the patient will not perform the action in response to implementation of the outreach option.

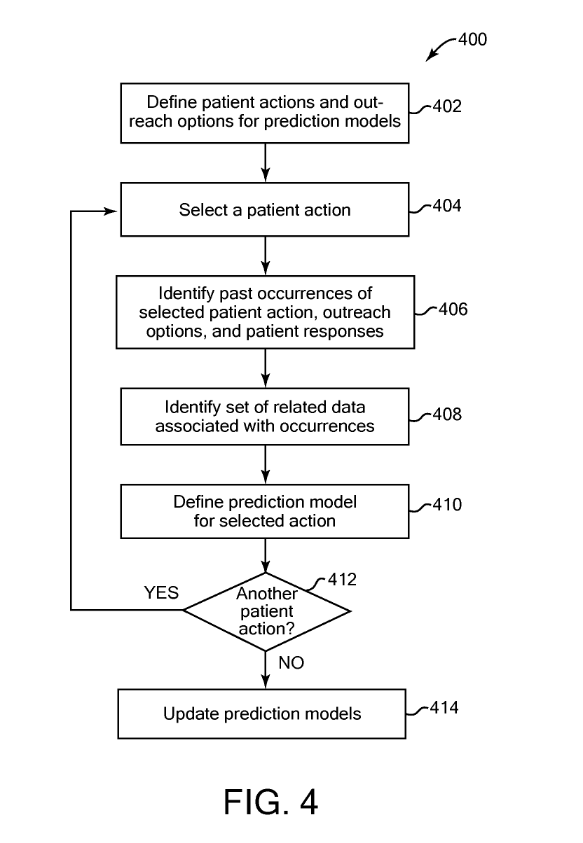

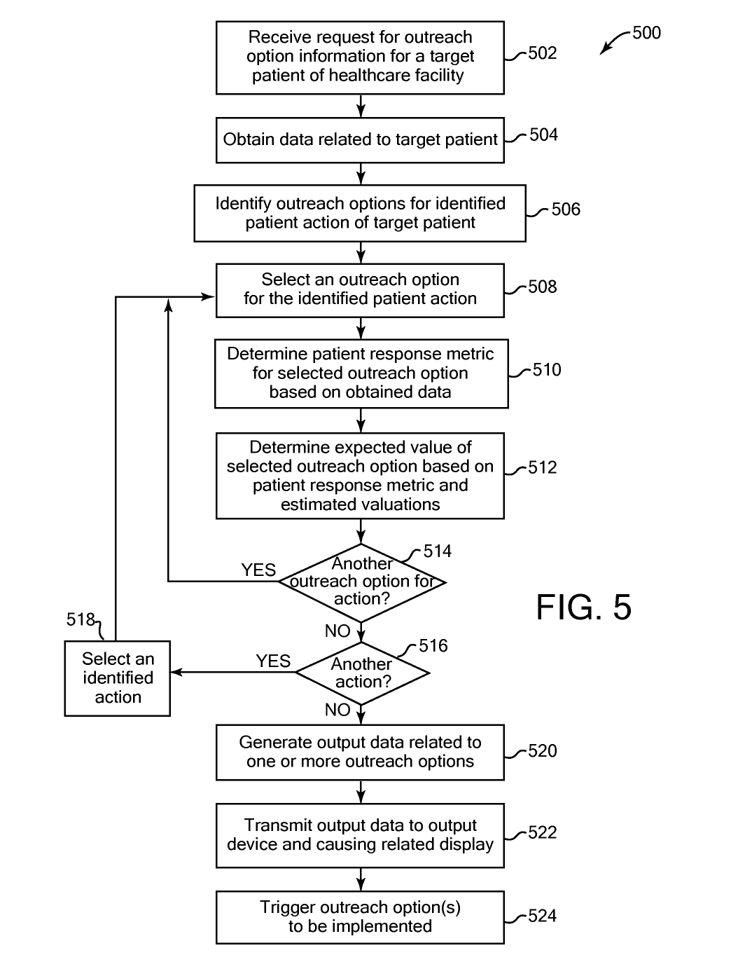

In some implementations, determining a patient response metric may involve two phases: (1) a modeling phase during which the data science system 304 defines (e.g., builds) one or more prediction models for predicting the probability of patient actions and (2) an application phase during which the data science system 304 utilizes the models defined in the modeling phase and other data for a given “target” patient to determine one or more patient response metrics for the target patient. An example modeling phase is described with respect to FIG. 4 and an example application phase is described with respect to FIG. 5.

### Example Data for Use in Determining Patient Response Metrics

Various types of data can be used in the determination of patient response metrics as described herein, some examples of which are now described.

In some implementations, the modeling phase of defining prediction models can make use of data relating to a group of patients, e.g., historical patient data related to patients. In some examples, the application phase can make use of data that relates to a particular target patient, e.g., current target patient data, historical target patient data, external patient data related to the target patient, and/or other data related to the target patient.

In some implementations, data can include facility data and external data. Some data (e.g., some facility data and/or external data) can also be described as patient data, e.g., related to patients of a healthcare facility. Some implementations can obtain data from different sources and/or organize data in different ways.

Facility data can be data generated and used by the healthcare facility and is related to healthcare facility operations and patients of the healthcare facility. In some implementations, facility data can be stored in data storage 204, 312, and/or 306 and/or facility data sources 106, and retrieved by the method 500. Examples of facility data can include facility operating data and facility patient data.

Facility operating data can include costs of services and medical supplies, outreach options generally performed and currently in use by the healthcare facility (and their costs), other operating costs and procedures. In some examples, facility operating data can include data describing current and historical operations of the healthcare facility. For example, the facility operating data can describe a history of such operations performed by the healthcare facility, and/or can describe guidelines, operating rules, and other facility procedures.

In some examples, the facility operating data can include a description, list, or enumeration of the outreach options that the healthcare facility implements for patients. The facility operating data can include a history of the outreach options previously implemented by the healthcare facility (and/or other facilities) and the time/date when such outreach options were implemented. The data can include a description of the outreach options the healthcare facility has available to perform. In some implementations, facility operating data can describe the outreach options and one or more medically-related patient actions associated with each outreach option. For example, an outreach option of emailing patients with reminders to set up doctor's appointments can be associated with a patient action of scheduling the doctor's appointment (and/or going to the doctor's appointment). In some implementations, the facility operating data can also include a general list or description of medically-related patient actions that patients can perform in response to outreach options.

The facility operating data can also include costs to the healthcare facility of past implementations of outreach options as well as estimated costs of future implementations. Costs to the healthcare facility (and/or to the patient) for treatment to patients can also be included, e.g., the cost of treatment enabled by patient actions.

Facility patient data can relate to particular patients of the healthcare facility. For example, facility patient data can be provided by the healthcare facility (and/or other healthcare facilities). In some implementations, facility patient data can include current patient data (e.g., health profile data) and historical patient data (e.g., historical patient actions related to the healthcare facility, outreach options performed for patients and corresponding patient responses, etc., patient financial history with respect to charges, payments, etc. for the healthcare facility, etc.).

For example, facility patient data can include current patient data and historical patient data related to the health condition, statuses, and prognoses of patients. For example, the facility patient data can include health profile data describing medical characteristics of patients (e.g., blood group, average blood pressure, temperature, height, weight, cholesterol readings, etc.), personal characteristics of patients (e.g., physical address, family members, place of birth, etc.), statuses such as current and past health issues or incidents (e.g., past or current incidents of colds, flu, cancer, chronic health conditions, etc.), the severity and/or other results of evaluations of health conditions of patients made by doctors, nurses, and other healthcare facility personnel (e.g., current ailments and severity, likelihood of future health conditions, etc.) and treatments received by patients (e.g., medications used, scans received, physical therapy received, etc.). The facility patient data can include various other data related to such patient characteristics, e.g., the healthcare personnel involved in treatment, date and time of occurrence of treatment, etc.

In some implementations, facility patient data can include data describing medically-related patient actions performed by particular patients of the healthcare facility. For example, historical patient data can describe a history of medically-related patient actions performed in the past by particular patients. For example, the patient actions can be actions performed by patients to receive health care from the healthcare facility, as described above. In some examples, facility system(s) 102 can store a description of the actions taken by each patient of the healthcare facility and the time/date that such actions were performed, such as the appointments the patients scheduled, the visits patients made to healthcare facility locations, the prescriptions enrolled in, etc. Health profile data describing facility personnel visited, prognoses and health evaluations, medicines or other treatments prescribed, etc. can also be associated with the particular patient actions. Some implementations can provide a history of patient actions taken by patients at other healthcare facilities, e.g., medical appointments and procedures undertaken, results from such appointments and procedures, prescriptions and medical items and supplies provided to patients, etc.

In some implementations, the facility patient data can include data that indicates one or more medically-related actions which the healthcare facility may desire particular patients to perform in the future, e.g., in response to one or more outreach options of the healthcare facility. In some examples, the medically-related actions can be input by healthcare facility personnel, or can be retrieved as a stored list or description that was previously determined, e.g., by healthcare personnel, facility system 102, and/or analytics system 104. In some implementations, one or more patient actions can be determined automatically by one or more systems based on other forms of patient data, e.g., a health profile of the target patient and/or other patients.

In some implementations, patient actions can be associated with one or more outreach options that were implemented (e.g., such prior outreach options can be stored in facility patient data and/or in facility operating data) and/or can be associated with one or more outreach options available to be implemented. For example, some implementations can store a lookup table (e.g., by a facility system 102 and/or analytics system 104) that includes outreach option data and patient action data, e.g., indicates associations of outreach options with each patient action available for evaluation by analytics system 104.

In some implementations, facility patient data can include historical data describing feedback data resulting from the performance of patient actions and/or outreach options. Feedback data may take various forms. For example, the feedback data can be patient response data indicating response statuses of patient actions performed by particular patients after implementation of particular outreach options, e.g., whether those patients performed the patient action that was associated with and intended by the outreach option. Examples of the response status can include that the patient action was performed, that the patient action was not performed (e.g., within a predefined time period after the outreach option was implemented), that a different patient action was performed, etc. Feedback data can be provided from various sources, examples of which include a patient-operated device such as a patient system 110, a facility system 102 that tracks patients and responses, etc. In some implementations, one or more facility systems 102 can aggregate feedback data over time and store such data in one or more databases, e.g., for each patient of the healthcare facility.

Facility patient data can include other historical response data or action data related to patients, including prior patient responses to calls, emails, text messages, etc. from the healthcare facility and the times of day and email address/phone number of such responses, the times and days of prior appointments at the healthcare facility attended by the patient, etc.

Facility patient data can include transaction data describing a financial transaction history (e.g., prior financial transactions) of patients with respect to the healthcare facility. For example, the transaction data can include descriptions of past monetary payments made by patients for treatments received from the healthcare facility (e.g., billing history), late payments made to the healthcare facility by patients and the amount of time that the payments were past due, unpaid balances of patients for health care treatments, monetary portions of health facility treatments covered by the patient's medical insurance, payment reminders sent to the patients by the healthcare facility, etc. The transaction data can include dates and times of the transactions, facility personnel involved with the transactions, etc.

External data can also be used to determine patient response metrics. External data can include external patient data, which may be current and/or historical patient data describing one or more characteristics of patients or history of actions of patients in contexts other than the healthcare facility. In some implementations, external data for a particular patient can be obtained in response to requests for the external data, e.g., for determining requested patient response metrics for that patient. In some implementations, external patient data can be obtained if patient permission is received by the analytics system 104 and/or healthcare facility 102.

The external patient data can include financial data describing a current financial status and/or a financial history of patients. For example, a financial history can include credit reports, credit scores, other information from a credit bureau, a history of payments made by a patient to other organizations or entities, historical financial status information, etc. For example, such financial data can be obtained from organizations such as banks, businesses, etc.

The external patient data can include geographic location data describing one or more locations associated with patients and locations associated with healthcare facilities. For example, location data can describe a geographic home location of patients and distances from the geographic home location to one or more geographic locations of the healthcare facility. Some location data can describe a geographic work location of patients and/or other locations associated with patients. For example, the location data can describe distances from a patient's home (or workplace) to healthcare facility locations such as a hospital, doctor's office, pharmacy, therapy center, specialist location, etc. In addition, the location data can include location history data describing a history of geographic locations visited by patients and a time and frequency of visits to the geographic locations by the patients.

Additional types of facility patient data and external patient data can be used in various implementations. Additional examples of facility patient data and/or external patient data that can be obtained and used can include other socioeconomic data and demographic data, e.g., patient age, occupation, family situation, history of home and work locations, etc.

In some implementations, facility data can be obtained from the healthcare facility itself and/or from associated other healthcare facilities. For example, partner hospitals or affiliated other healthcare facilities (e.g., external doctor practices) can contribute data, and/or such facilities can pool their data together, to be available to the analytics system 104.

### Examples of Defining Prediction Models

Some implementations can determine prediction models in advance before an application phase is begun. For example, the prediction models can be defined in the modeling phase based on data related to multiple patients, e.g., a large population of patients in some implementations. Then the application phase can be initiated based on a request for output related to patient response to outreach options for a particular target patient. In other implementations, the application phase may be initiated, e.g., by a request for output related to patient response to outreach options for a target patient, such that prediction models are then defined and/or updated during a modeling phase, and the application phase is then continued to apply defined models to provide the requested output.

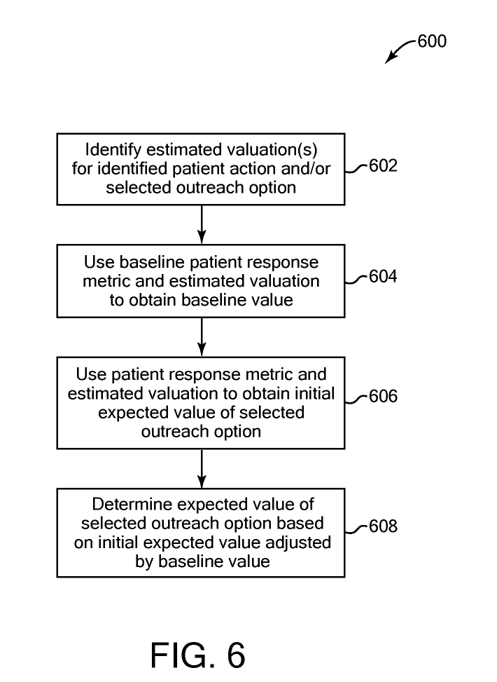

FIG. 4 is a flow diagram 400 depicting an example method implementing a modeling phase that may be used for determining one or more predictive models for use in determining patient response metrics. In some implementations, this modeling phase can, for example, be performed to define prediction models before an application phase is begun. In some implementations, the modeling phase can be performed during an application phase, e.g., after a request is received for output related to a target patient, as described below with respect to FIG. 6.

For purposes of illustration, the example modeling phase is described as being carried out by the data science system 304, but this modeling phase may be carried out completely or partially by other systems as well, e.g., one or more other components of a central platform 101, facility systems 102, or other systems. Numerous other combinations of operations may be utilized to determine a prediction model in other implementations.

As shown in FIG. 4, at block 402, the data science system 304 may define a set of one or more patient actions and one or more outreach options that form the basis for the patient response metric. Based on the defined set of patient actions and outreach options, the data science system 304 may define a prediction model for predicting a probability of a patient performing a medically-related patient action in response to an implemented outreach option.

As described above, a medically-related patient action can be an action (e.g., type of action) that is to be performed by patients to further a medically-related goal of the target patient. As described above, an outreach option can be implemented to cause or facilitate patients in performing a medically-related patient action, e.g., can be implemented by a healthcare facility. In some implementations, an outreach option may take the form of a single outreach effort or task, or multiple outreach efforts or tasks.

Some implementations may define different outreach options, where each outreach option can include one or more different combinations of individual outreach efforts or tasks. For example, a first outreach option can include a first outreach effort and not a second outreach effort, while a second outreach option can include both the first and second outreach efforts. Each of these outreach options can be evaluated separately. In some implementations, all possible different combinations of individual outreach efforts can be defined as outreach options from a set of outreach efforts, while other implementations can define only some of the possible combinations of individual outreach efforts as outreach options. In one example, outreach option 1 is defined to include effort A and effort B, outreach option 2 is defined to include only effort A, and no outreach option is defined that only includes effort B because effort B is not relevant to the associated patient action, or is not valid for the healthcare facility, etc.

Some implementations can provide a designated order for multiple individual outreach efforts in an outreach option to be implemented sequentially. Further, some implementations can define different outreach options, where each outreach option has a different ordering of a same set of outreach efforts. In one example, one identified outreach option can designate a first outreach effort to be implemented first and a second outreach effort to be implemented second, and a different outreach option can designate the second outreach effort to be implemented first and the first outreach effort to be implemented second. Some outreach options can include three or more outreach efforts to each be implemented in a particular order. Some implementations can designate multiple individual outreach efforts in an outreach option to be implemented simultaneously.

In some implementations, the set of patient actions and outreach options can be defined as a number of associations, pairs or groups of a particular patient action with one or more particular outreach option(s). For example, for each particular patient action, there may be a set of outreach options that are associated with that patient action, e.g., that are relevant to that patient action. For example, outreach options of sending an email to a patient, sending mail to a patient, or calling a patient may be relevant to a patient action of visiting a doctor at the healthcare facility, and that patient action can be associated with each of those outreach options. However, an outreach option of visiting the patient by healthcare personnel may not be relevant to that patient action, and so the visit outreach option may not be defined for or associated with that patient action.

In some implementations, the set of patient actions and outreach options can be defined as a set of patient actions and a set of outreach options.

In one example, the set of the patient actions and outreach options may be based on one or more user inputs. Specifically, the data science system 304 may receive from a computing system operated by a user, such as a facility system 102 operated by healthcare personnel or an administrator using the system 304, input data indicating a user selection of the patient actions and associated outreach options to be processed for use in determining output as described herein. For example, the user input can indicate the patient actions and outreach options to be processed for the predictive models. As such, the set of one or more patient actions and outreach options may be user defined. For example, in some implementations, a healthcare facility may indicate to a user which outreach options that the facility will be able to implement and/or which patient actions that the facility wishes to evaluate. The healthcare facility can, in some implementations, indicate which outreach options are associated with which patient actions. A user can input that data to the system 304 to define the patient actions and outreach options, e.g., specific associations of patient actions and outreach options. In some implementations, a set of patient actions can be user defined, or a set of outreach options can be user defined.

In some examples, the analytics system 104 may consult a stored lookup table that lists the associations of outreach options with each possible patient action that can be evaluated, and which defines the pairs of patient actions and outreach options. In some implementations, a lookup table can be defined for each particular healthcare facility for which the analytics system 104 provides output. For example, each such healthcare facility can have its own list of outreach options that it desires to be implemented, associated with its own list of patient actions.

In other examples, the data science system 304 may be configured to define some or all of the set of one or more patient actions and outreach options. For example, the set of patient actions and outreach options can be defined as each combination of patient action and outreach option from a given set of patient actions and a set of outreach options. The set of patient actions and set of outreach options can be determined based on historical data stored in the databases 306 and/or external data provided by the data sources 106, for example.

In another example, the data science system 304 may be configured to define patient actions and outreach options based on historical patient data. For example, the data science system 304 may examine such historical patient data to determine which implemented outreach options have historically been followed by which patient actions performed by patients, so that viable and/or common associations of patient actions and outreach options are determined. In some implementations, the data science system 304 can define patient actions and outreach options in other ways. In still other examples, the set of one or more patient actions and outreach options may be defined based on a combination of user inputs and determinations made by the data science system 304. Other examples are also possible.

In block 404, the data science system 304 may select one of the patient actions (e.g., patient action types) defined in block 402.

In block 406, the data science system 304 may identify past occurrences of the patient action selected in block 404. For example, the data science system 304 may analyze historical patient data for a group of patients to identify past occurrences of the performance of the selected patient action by the patients. The selected patient action may have been performed by patients in response to one or more outreach options having been implemented, e.g., by the healthcare facility or other facility or system, and these outreach options can also be identified. Other outreach options may also be identified for the selected action, e.g., based on predefined associations, a list or lookup table, etc.

For example, in some implementations, for the selected patient action, the data science system 304 may analyze historical patient data for a group of patients to identify past occurrences of performances of the selected patient action by the patients, and/or to identify outreach options that were implemented in advance of the selected patient action. For example, the group of patients may include patients of the healthcare facility and/or other healthcare facilities. The data science system 304 may analyze a particular amount of historical patient data, such as a certain amount of time's worth of data (e.g., three years' worth) or a certain number of data-points (e.g., the most recent 100 data-points), among other examples.

For example, the historical patient data may include stored instances of patient responses (e.g., patient response data) indicating performances of the patient action, and stored instances of implementation of outreach options. In some implementations, the method can examine historical facility operating data to determine historical patient action and outreach option data.

In some cases, the data science system 304 may locate, from historical patient data stored in the databases 306, indications of the selected patient action having been performed, such as patients signing up for a plan, patients visiting a healthcare facility location, etc. In some cases, the data science system 304 may locate from facility operating data indications of outreach options having been implemented, such as emails being sent, calls being placed, or visits to patients having been performed by healthcare personnel, etc. In some implementations, for identified outreach options, the system 304 can determine if the selected patient action was performed after each given outreach option was implemented, e.g., within a threshold time period after an outreach option was implemented.

In some implementations, once an occurrence of the patient action is located in the historical patient data, the system 304 may identify times at which associated outreach options were implemented and times at which the patient action occurred by patients. The system 304 may also identify whether patients did not perform the patient action in response to outreach options, e.g., within a threshold time period after a given outreach option was implemented. For example, system 304 can identify, from the historical patient data, responses of patients to an identified outreach option (e.g., patient response). For some outreach options, the patient response to an outreach option was a recorded patient action performed by patients. For example, the method can examine data covering a predetermined time span after the occurrence of each identified outreach option. In some cases, the patient response may have been to not perform the selected patient action. The method can identify occurrences of the absence of performing the selected patient action in response to outreach options.

The data science system 304 can also identify occurrences of patients performing the selected patient action without any outreach option being implemented, e.g., in advance of that patient action (e.g., within a threshold time before the patient action). For example, such occurrences can be used in determination of baseline probabilities as described below.

At block 408, the data science system 304 may identify a respective set of related data that is associated with identified past occurrences of the selected patient action and identified outreach options. For example, the data science system 304 may identify a set of related data from a certain timeframe around the time of the given occurrence of the selected patient action and/or identified outreach options. For example, the set of related data may include related patient data including the health profiles, healthcare financial data, and external data relating to the patients who performed the selected patient action. The set of related data can include external data relating to the patients who performed the selected patient action.

In block 410, the data science system 304 defines a prediction model for the selected patient action. In operation, as described below with respect to FIG. 5, a defined prediction model may receive input relating to a particular target patient including patient data for that target patient. In some implementations, the prediction model determines and outputs an indication of a probability that the target patient will (or is likely to) perform the selected patient action in response to one or more particular outreach options. In some implementations, the prediction model can output a probability that the target patient will not perform the selected patient action in response to one or more particular outreach options. In general, the prediction model may define a relationship between the selected patient action, one or more outreach options, and the probability of a particular patient performing the selected patient action. For example, the prediction model can output a patient response metric indicating this probability.

The defined prediction model can be configured to provide an output probability for the selected patient action in response to any specified outreach option. For example, each identified outreach option for the selected patient action can be input separately to the prediction model to obtain an output probability for that outreach option. Each outreach option to be evaluated by the model can be associated with its own respective output probability. In some examples, the prediction model can be configured to evaluate any of the possible outreach options that a healthcare facility can implement, e.g., any of the outreach options defined in block 402.

The prediction model may be defined in a number of different ways, e.g., using any of various prediction algorithms or techniques. In some implementations, the method may define a prediction model by utilizing one or more machine learning modeling techniques, e.g., supervised learning techniques, that return a probability between zero and one, such as a random forest technique, logistic regression technique, Bayesian linear regression models, support vector machines, Bayesian neural networks, Gaussian processes, probabilistic principal component analysis, Bayesian networks, naive Bayes model, and/or other technique. Other types of predictions models can also or alternatively be used.

The prediction model may be defined and/or trained based on a variety of types of information. For example, the data system 304 can analyze historical patient data, including the past occurrences determined in block 406 of one or more identified outreach options, patient responses to identified outreach options, and the selected patient action, to define the prediction model. In some examples, the prediction model can be based on patient actions and other responses of patients historically occurring in response to prior outreach options, e.g., whether patients responded to an outreach option by performing the selected patient action, or responded in another way (for example, by not performing the selected patient action or by performing a different patient action). The prediction model also may be defined based on the time between prior occurrences of identified outreach options and patient responses to those occurrences, the frequency of selected outreach option implementation and patient responses, one or more patterns indicating patient response trends around the occurrence of identified outreach options, etc.

In some implementations, the prediction model can be defined to include analysis of patient responses to no outreach options. For example, the system 304 can analyze past occurrences of the selected patient action without an outreach option having been implemented. This can allow the prediction model to output a baseline patient response metric indicating the probability without the influence of an outreach option having been implemented.

The prediction model also may be defined based on other historical patient data including facility patient data and/or external patient data of patients (e.g., financial data, transaction data, and/or location data for patients). This data can be examined and analyzed for factors and trends that can be the basis for additional inputs and processing in the model to affect the output (e.g., prediction) of the prediction model.

In some implementations, historical patient data relating to the selected patient actions and/or identified outreach options can be analyzed to influence the prediction model. In some implementations, historical patient data relating to one or more other patient actions can also be analyzed to influence the prediction model.

For example, facility patient data such as patient financial transaction data and history with the healthcare facility for patients can be used to affect the prediction model. In one example, the system 304 can analyze past payments of patients to a healthcare facility as determined in transaction data of patients to determine if there is any correlation between or trend in patient payments and patient response to an outreach option. In one example, historical transaction data may show a trend that patients late in paying the healthcare facility for prior treatment are less likely to perform the selected patient action, e.g., the patients may be avoiding contact with the healthcare facility due to the overdue payments. Based on this historical facility patient data, the model can include adjustments to probability estimation that are based on a current payment status of a patient. For example, the prediction model can include an input to receive an indication of the current healthcare payment status of a particular patient, and the model can determine its output at least partially based on this input, e.g., reduce an output probability for the particular patient if an indication of late payment status is received.

Similarly, the prediction model can be influenced by historical data related to a group of patients. In some implementations, the patients in the group can be a large population of patients. For example, the patients in the group can include patients of the healthcare facility and/or patients of one or more other healthcare facilities (if appropriate data is available). In one example, the system 304 can analyze past credit reports in financial data of patients to determine if there is any correlation between or trend in patient credit score and patient response to an outreach option. For example, lower credit scores for patients may be found to be correlated with reduced performance of patient actions by patients. Based on this historical financial data, the model can include adjustments to probability estimation that are based on financial conditions of patients. For example, the prediction model can include one or more inputs to receive indications of the current financial status of a particular target patient for which a probability is to be determined (e.g., in FIG. 5 described below), and the model can determine its output based on this input, e.g., reduce an output probability for the target patient if an indication of a lower credit score is received for that target patient.

In some implementations, each of various types of financial conditions of a patient can be an input to the prediction model and influence the output of the model (e.g., adjusting the output probability determination of the prediction model).

In another example, historical geographic location data associated with patients can affect the prediction model. In one example, the system 304 can analyze past locations of patients and distances between patients and healthcare facilities as determined from location data of patients to determine if there is any correlation between or trend in patient location or distance and patient response to an outreach option. For example, the system 304 may find in the location data a trend indicating increased occurrences of the selected patient action if patients' homes or workplaces are located a short distance from a healthcare facility location (e.g., under a threshold distance, or an approximately linear relationship between patient location and healthcare facility location). Based on this historical location data, the model can be defined to include patient location in the determination of a probability output. For example, the prediction model can include one or more inputs to receive indication of a distance between a particular target patient location and a particular healthcare facility location. The model can determine its output at least partially based on this input, e.g., reduce an output probability for the particular target patient the greater the distance between patient location and healthcare facility location.

In some implementations, based on the historical patient data, different inputs and/or probability adjustments can be included in the prediction model for different patient locations, different healthcare facility locations, etc. For example, the prediction model may use a different adjustment factor for patient home locations than for a patient work locations, e.g., based on historical patient data indicating that patient responses to outreach options were typically different when patients traveled from one location and the other location. In one simplified example, financial data and location data may indicate that financially-successful patients (e.g., over a threshold income) having a home within 5 miles of a healthcare facility location are more likely to perform the selected patient action in response to the selected outreach option. The prediction model can be defined (or adjusted) to increase probability of patient action by a particular amount based on the data, for patients having these characteristics.

In some cases, historical data and/or external data may require formatting prior to applying the prediction model to the data. Such operations may include compression and/or decompression, encryption and/or de-encryption, analog-to-digital and/or digital-to-analog conversion, filtration, and amplification, among other operations. Moreover, the system 304 may be configured to parse, sort, organize, and/or route data based on data type and/or characteristics of the data. In some examples, the system 304 can receive geographical location data (e.g., geographical coordinates) and determine distances between patient and a healthcare facility location for input to the prediction model.

In block 412, after the prediction model is defined, the data science system 304 checks if there is another patient action to process from the patient actions defined in block 402. If so, the system 304 selects a different patient action in block 404 and determines a prediction model for that patient action in blocks 406 to 410. In this way, a prediction model can be defined for each patient action defined in block 402.

Other prediction models, and techniques to build such prediction models, can also or alternatively be used. For example, in some implementations, instead of a separate model being defined for each patient action as described above, a prediction model can be defined to determine probabilities for any of multiple different patient actions. For example, any combination of a particular patient action and a particular outreach option can be designated for evaluation by the model as one or more of the inputs to the model. In some examples, the data science system 304 may determine a single prediction model that encompasses and is determined based on all of the patient actions and outreach options defined at block 402, as well as all patient data and other data relevant to such patient actions and outreach options.

In some implementations, other prediction models can be defined. For example, a respective prediction model can be defined for each identified pair of defined patient action and defined outreach option, where possible pairs of patient action and outreach option can be defined in block 402 (e.g., partially based on historical data in some implementations). A baseline prediction model can also be defined for each defined patient action in response to no outreach option. For example, such a baseline prediction model can indicate a probability that a patient will perform (or alternatively, not perform) a particular patient action in the absence of implementation of outreach options. In general, the baseline prediction model may define a relationship between a selected patient action and the probability of a particular patient performing the selected patient action, in the absence of any outreach options.

In additional examples of other prediction models, some implementations can define a prediction model for each defined outreach option, where a patient action for such a prediction model can be input to the model for evaluation via one or more of the inputs to the mode. In another example, a prediction model can be defined for each defined patient action, where a particular outreach option for that patient action can be input to the model for evaluation via one or more of the inputs to the model. Other examples are also possible.

In block 414, the data science system 304 may update the defined prediction models over time. For example, additional or updated patient data may be received from data sources 106, patient systems 110, facility systems 102, etc. In some implementations, the data science system 304 can use output of the data science system 304 over time to update predictive models, e.g., identify variables that influence patient response metrics and patient responses. In some implementations, the data science system 304 can identify trends in the output and determine or estimate a potential cause or causes of such a trend, e.g., correlate other patient data with changes in patient response metrics (e.g., changes in home location for patients, change of employment, etc.). In some examples, a trend can be a threshold amount of change (e.g., an increase or decrease) in a threshold number of patient response metrics over a certain period of time, approximately constant patient response metrics for a certain amount of time, a threshold amount of increase followed by a threshold amount of decrease, etc.

The system 304 can update prediction models in response to adding new data to its analysis, e.g., to adjust probability determination and other factors used in the models, etc. In some implementations, the data science system 304 may update a prediction model periodically, e.g., daily, weekly, monthly, etc. In some examples, as the data science system 304 continues to receive updated patient data for one or more patients, the data science system 304 may also continue to dynamically refine the predictive models for the defined pairs of patient actions and outreach options by repeating blocks 404 to 414 using the updated patient data. Prediction models can be updated dynamically based on feedback data such as patient response data. For example, the model can be updated dynamically as a patient performs a patient action as tracked by a healthcare facility system 102. In one example, the feedback data can cause the method to add a past occurrence to patient data and include this new data in applying the predictive model, and/or adjust a particular predictive technique using data that has been updated. Other examples are also possible.

### Examples of Determining Output Related to a Target Patient

FIG. 5 is a flow diagram illustrating an example method 500 to provide output indicative of predicted response of a target patient to one or more outreach options. For example, method 500 can be used to determine one or more patient response metrics indicating whether the target patient is likely to perform a medically-related patient action in response to particular outreach options, and can provide output related to patient response metrics. The outreach options can facilitate a patient in achieving a medically-related health goal for the patient. In some implementations, method 500 can implement an application phase of determining patient response metrics, in which one or more prediction models are applied to provide output based on input data.

In some examples, operations of method 500 can be performed by one or more components of the healthcare network configuration 100 shown in FIG. 1, such as the analytics system 104.

In block 502, a request is received for information related to one or more outreach options for a particular patient (e.g., “target patient”) of the healthcare facility. For example, the request can be received at analytics system 104. In some examples, a user such as healthcare facility personnel may have input the request in a facility system 102 located at or in communication with the healthcare facility, e.g., using an input device as described above, and the request can be transmitted from the facility system 102 to the analytics system 104. In some examples, the facility personnel may desire to receive one or more forms of output related to the target patient as provided by features described herein. Herein, the term “user” can refer to a person interfacing with a system or an automated program (e.g., a “bot”), device, or virtual entity interfacing with the described systems of healthcare facility network configuration 100.

In some implementations, the request can be received from a different system, device, or program. In an example scenario, a facility system 102 can be automatically configured to trigger the request to the analytics system 104 under certain circumstances, e.g., in response to an update to a medical record and/or other patient data of the target patient. In another example, healthcare personnel such as a doctor or nurse can input information to a facility system 102 based on a recent target patient visit, and then the facility system 102 is configured to then analyze the new information and automatically initiate the request to the analytics system 104 in response to this input.

In some examples, the request includes an identification of the target patient. The request may also include an indication of a medically-related patient action that the target patient needs to perform. For example, a user inputting the request may have input the indication of the medically-related patient action, e.g., selected from a menu displayed in a graphical user interface of a facility system 102, input in a command line interface of the facility system 102, etc. In some implementations, the facility system 102 can determine a medically-related patient action based on the target patient identification input by a user and based on target patient data, e.g., a target patient health profile including medical diagnoses and recommendations, prescriptions, etc.

In some implementations, the received request can include indications of one or more outreach options of interest. Some implementations can include a request for the healthcare computing system to trigger the automatic implementation of one or more outreach options for the target patient, if appropriate for the healthcare facility network configuration as described below.

In some implementations, no request may be received in block 502, and/or no identification of a target patient may be received, and the analytics system 104 can automatically select a target patient, without human intervention, for which to determine information and/or provide output. For example, the analytics system 104 can determine output data for one or more target patients without receiving a request, e.g., to provide pre-computed output data that is ready to deliver upon receiving a future request.

In block 504, the analytics system 104 obtains data related to the target patient, e.g., from data sources 106 and/or other systems of the network configuration 100. A variety of forms of data can be obtained in block 504, including target patient data related to the target patient. For example, the target patient data can include health profile data, facility patient data, and external patient data for the target patient. In some implementations, historical target patient data can also be obtained for use with method 500, including a history of outreach options implemented for the target patient and prior actions and other responses of the target patient to outreach options.

In block 506, the analytics system 104 identifies one or more outreach options for an identified medically-related patient action for the target patient. In some implementations, the identified medically-related patient action was received in the request of block 502, e.g., is an action that may be performed by the target patient to further a medically-related goal of the target patient. For example, a healthcare facility 102 may have determined the patient action for the target patient and included the patient action in the received request.

In some examples, the patient action was input by a user in a system, e.g., a facility system 102. In other examples, the patient action can be identified automatically, e.g., by a facility system 102, based on target patient data. For example, a facility system 102 may identify patient actions based on retrieved target patient data including a list or description of one or more patient actions to evaluate for the target patient. The facility system 102 may automatically identify patient actions based on target patient data such as health profile data of the target patient. For example, associations between health profile data and patient action(s) can be predefined by healthcare personnel, e.g., in a lookup table, list, or other stored relationship. In other implementations, the facility system may automatically determine associations between a health profile and particular historical patient actions, such as prior treatments described in the health profile and prescribed for the target patient, to determine one or more patient actions associated with those treatments. In one example, a prescribed treatment to ingest particular medicine can be associated with a patient action for renewing a prescription of that medicine by a particular date. In some implementations, the facility system 102 can determine an association based on predefined relationships between keywords, key phrases, or recognized semantic meanings and/or synonyms determined from database or knowledge base data. For example, a treatment including the word “tablets” may indicate a prescription renewal action. In some implementations, machine learning techniques can used, e.g., based on training a method with sample treatment descriptions and health status descriptions, and associating desired patient actions with those descriptions. In some implementations, the analytics system 104 can automatically determine the patient action, e.g., using any of these techniques.

Some implementations can select the identified patient action from multiple medically-related patient actions that further the medically-related goal.

The analytics system 104 identifies one or more outreach options to evaluate in block 506. An outreach option can include one or more specific outreach efforts or tasks that can be implemented to cause (or facilitate) the target patient to perform the identified patient action, as described above. In some implementations, the outreach options identified in block 506 can be identified automatically without human intervention. For example, the identified outreach options may have been previously associated with the identified medically-related patient action. Such associations can be included in outreach option data. For example, some implementations can consult a stored lookup table that includes outreach option data, e.g., lists associations of outreach options with each patient action to be evaluated as described above for FIG. 4. The analytics system 104 can consult the lookup table to identify the outreach options for the identified patient action.

In some implementations, the analytics system 104 can identify outreach options without use of a lookup table, e.g., retrieve outreach option data including a stored list or description of one or more identified outreach option to evaluate for the target patient, and evaluate each outreach option, e.g., for each identified patient action.

In some implementations, the one or more identified outreach options can be identified automatically by the analytics system 104 based on target patient data obtained in block 504. For example, the analytics system 104 can examine historical facility operating data and/or historical patient data to find outreach options that have been implemented previously by the healthcare facility and in association with the identified patient action previously performed by the target patient, and can select those outreach options as identified outreach options.

In some implementations, one or more of the identified outreach options can be input or designated by a user, e.g., in outreach option data included the received request of block 502.

Some implementations may identify different outreach options to evaluate, where each outreach option can include one or more different combinations of individual outreach efforts or tasks. For example, these different identified outreach options may have been previously defined, e.g., by a facility system 102 or by the analytics system 104 during definition of prediction models of FIG. 4 as described above.

In some implementations, one of the identified outreach options can be no outreach option, e.g., an absence of outreach options for the identified patient action. This can allow the system 104 to determine output for the target patient related to the circumstances of no outreach options being implemented, e.g., a baseline patient response metric as described below.

In block 508, the analytics system 104 selects an identified outreach option to evaluate for the identified medically-related action. For example, the method selects one of the outreach options identified in block 506.

In block 510, the analytics system 104 determines a patient response metric based on the target patient data obtained in block 504, where the patient response metric is associated with the selected outreach option. The patient response metric can indicate a probability that the target patient will perform the identified patient action in response to the selected outreach option. For example, the method can apply a prediction model to determine the patient response metric.

For example, the analytics system 104 can use a prediction model particularly associated with the identified patient action as described above with respect to FIG. 4 to determine the patient response metric. In some examples, the selected outreach option can be input to one or more inputs of the prediction model. For example, in some implementations the selected outreach option can identified to the prediction model in an input to the prediction model. In one example, a prediction model for the identified patient action may be used to provide a patient response metric for any of four possible outreach options of a healthcare facility: Possible Plan 1, Possible Plan 2, Possible Plan 3, and no outreach option (e.g., baseline patient response metric). Any one of these outreach options can be specified and selected in an input to the prediction model, e.g., as a value such as an integer that can take values of 1, 2, 3, or 0 depending on the outreach option to be evaluated, in one example. The selected outreach option can be evaluated by the prediction model to provide the patient response metric.

In some implementations, if the selected outreach option is an absence of an outreach option, the analytics system 104 can determine a baseline patient response metric that does not include influence of the selected outreach option, e.g., indicates a probability that the patient will perform the selected patient action in the absence of the selected outreach option. In some implementations, a baseline patient response metric can be used to determine expected value as described with reference to FIG. 6.

In addition, data of one or more types related to the target patient can be input into one or more inputs of the prediction model. In various examples, target patient data (e.g., current health profile data of the target patient), historical target patient data (e.g., history of patient actions performed and outreach options received by target patient), and external patient data (e.g., financial history and location data relating to the target patient) can be input to the model. Based on such inputs, the prediction model outputs the patient response metric.

Various processing may be performed to data before inputting it to the model, as described above. For example, some implementations can process location data into distances between locations, where the distances are input to the model. Some implementations can analyze target patient data, the selected action, and/or the selected outreach option to determine input data for the model. For example, if the selected outreach option is intended to cause the target patient to perform the selected patient action of visiting a facility location, the time of the intended visit to the facility location can be analyzed by the analytics system 104 to determine the target patient's likely location at a time of departure for the visit, e.g., at home or at work as based on target patient data. The analytics system 104 can determine the distance between the target patient's likely location and the facility location and input that distance to the prediction model.

In some implementations, a prediction model that can evaluate any of multiple patient actions can be used, e.g., where the identified patient action can be selected for evaluation as input to one or more inputs of the model. In some implementations, multiple prediction models can be used. For example, if prediction models for particular outreach options are used, the individual outputs of these prediction models can be combined, e.g., averaged, summed, a maximum or median found, etc. to provide a combined patient response metric for output or for use, e.g., in determining expected value as described below.

In block 512, the analytics system 104 may also determine an expected value of the selected outreach option based on the patient response metric determined in block 510 and based on one or more estimated valuations. The estimated valuations can be associated with the identified patient action and/or with the selected outreach option. For example, the expected value can indicate the value to the patient and/or to the healthcare facility of performing the selected outreach option with respect to the identified patient action. Some examples of determining an expected value for the selected outreach option are described below with reference to FIG. 6. In some implementations, the method does not perform block 512.

In block 514, the analytics system 104 checks whether there is another identified outreach option to evaluate for the identified patient action. For example, if multiple outreach options were identified in block 506, then there may be outreach options that have not yet been evaluated in blocks 508-512. If there is another outreach option to evaluate, the method returns to block 508 to select an outreach option for evaluation.

If there are no further identified outreach options to process as checked in block 514, the analytics system 104 may perform block 516 in which the analytics system 104 checks if there is another identified medically-related patient action to evaluate. For example, the medically-related patient action identified in block 506 may have been one of multiple identified medically-related patient actions which can further the medically-related goal. In one example, one identified patient action may be to visit a healthcare facility location for a doctor's appointment for the patient's back pain, while another identified patient action may be to enroll in a plan to receive prescription medication to relieve the back pain. If there are more identified patient actions to evaluate, then the method can continue to block 518 to select another identified medically-related patient action, and the method then returns to block 508 to evaluate identified outreach options associated with the newly-selected patient action.

In some implementations, other variations or combinations of patient actions and/or outreach options can be evaluated in blocks 508-512, e.g., causing a return to block 508 to evaluate a different variation or combination. For example, different times at which an outreach option is implemented may provide different results for a patient response metric and/or an expected value in the evaluation of blocks 508-512. In some implementations, each of multiple different times of implementing a particular outreach option can be evaluated separately, e.g., over multiple iterations of blocks 508-512.

If there are no further identified patient actions to process as determined in block 516, the method continues to block 520 in which the analytics system 102 generates output data related to one or more outreach options. In various examples, the generated output data can indicate one or more outreach options for identified patient actions, patient response metrics, expected values, and/or recommendations identified or determined in method 500. In some implementations, the output data can be based on one or more patient response metrics determined for one or more of the identified outreach options as described above. For example, output data can indicate a non-ordered list of outreach options with corresponding patient response metrics, or an ordered list of outreach options (based on patient response metrics) without a display of patient response metrics. In some implementations, the output data can alternatively or additionally indicate one or more expected values for one or more identified outreach options as described above.

In some examples, the analytics system 102 may include patient response metrics and/or expected values in output data or use them to modify or determine output data. For example, one or more patient response metrics may be output by a prediction model in a presentation form that may be directly included in output data. In some implementations, the patient response metric may require further configuring or processing to be included in output data. In some examples, patient response metrics and/or expected values may be configured to be presented in the form of numbers, tables, graphs, text, audio, etc. Some implementations can process a patient response metric and/or expected value into other forms of indications. For example, a patient response metric that is a numerical probability value can be configured into text, graphics, or other form indicating one or more categories of output, such as “patient is likely to perform the patient action” or “patient is not likely to perform the patient action.” Such output categories can be based on thresholds, e.g., a probability value above a particular threshold can indicate the patient is likely to perform the patient action, and probability values below the threshold can indicate the opposite.

In some implementations, the generated output data can alternatively or additionally indicate a prioritization of outreach options. For example, output data can indicate a prioritization of one or more of the evaluated outreach options based on their associated patient response metrics and/or estimated values, and the output data can include an indication of the prioritization for display. For example, analytics system 104 can prioritize outreach options based on a ranking and/or scoring of one or more of the selected outreach options based on the patient response metrics and/or expected values. E.g., patient response metrics indicating a higher probability of patient response can be ranked higher in the prioritization. In one example, if the expected value of a first outreach option is more favorable to patient or healthcare facility (e.g., a higher value) than the expected values of the other evaluated outreach options, the first outreach option can be ranked highest of these outreach options. Outreach options can be ranked based on other measures in some implementations. In some implementations, an option to perform no outreach options can also be evaluated and/or ranked (e.g., based on a baseline patient response metric and/or baseline value as described above and for FIG. 6).

In some implementations, the generated output data can indicate a recommendation of one or more of the evaluated outreach options to be implemented. In some examples, a recommendation can be based on the prioritization described above. For example, a recommendation can include one or more highest priority, e.g., highest-ranking, outreach options for an identified patient action. In some implementations, a predetermined number of the highest ranking outreach options (with their associated identified patient action(s)) can be included in a recommendation. Some implementations can include other ranks or prioritizations of outreach options (e.g., lower ranking outreach options) in a recommendation. In some implementations, the recommendation can indicate that no outreach options should be performed by the healthcare facility for the target patient if the expected value of implementing no outreach options is equal to or more favorable than expected values of the evaluated outreach options.

Some implementations may have evaluated different combinations of identified patient actions and outreach options as described above. For example, each combination of outreach option and identified patient action can be separately ranked in block 520 for a recommendation.

In block 522, the analytics system 104 may transmit the generated output data to an output device. The output data can cause or facilitate display by the output device of a representation of one or more outreach options. In various implementations, the output data can cause or facilitate display by the output device of a representation of one or more outreach options, patient actions, patient response metrics, expected values, and/or recommendations indicated in the output data. For example, the analytics system 104 can transmit output data to an output device such as a display device of the analytics system 104 and/or a display device of one or more facility systems 102. In some implementations, a facility system 102 can transmit the output data to a display device of a facility system or other system. In some implementations, the requestor who provided a request in block 502 can receive the output representation on an associated output device.

In some implementations, blocks 520 and 522 can be omitted and, for example, block 524 can be performed.

In block 524, the analytics system 104 may facilitate an automatic execution, without human intervention, of at least one outreach option from the identified outreach options, or trigger such an automatic execution. For example, the analytics system 104 can provide a command to trigger or cause one or more outreach options to be implemented, e.g., by the analytics system 104, by a facility system 102 or other system of the healthcare facility, by a different computing system, etc. In some examples, a commanded system can perform or trigger outreach options including sending an electronic message to the target patient (e.g., sending an email to a patient system 110 via the target patient's email address), calling the target patient (e.g., placing an automated phone call to the target patient at a patient system 110 or other device using an automated phone call system), generating a letter to be sent to the target patient via physical mail (e.g., causing a letter to be delivered using a mail delivery service), and/or scheduling one or more healthcare personnel to visit the target patient at a geographical location (e.g., sending visit schedule information to calendars, accounts or addresses of healthcare facility personnel and/or patient systems 110).

In various implementations, block 524 can be omitted, or can be performed additionally or alternately to the transmission of output data in block 522.

Some implementations can perform one or more of the blocks of FIG. 5 based on events or triggers received by a facility system 102 and/or analytics system 104. In some implementations, new patient response metrics and/or expected values can be automatically and dynamically determined and/or output by the blocks of method 500 in response to receiving or determining new patient data, new patient actions, new outreach options, or in response to an update of the prediction model. In some implementations, based on a predefined condition or trigger (e.g., a patient response metric or an expected value reaching a threshold value), the analytics system 104 may automatically, without human intervention, generate any of the output data described above. In some implementations, the analytics system 104 may receive feedback data indicating a new condition that causes the method to change output data. For example, feedback data can indicate that a target patient no longer uses a telephone such that phone call outreach options to that patient are no longer feasible. Based on such feedback, the analytics system 104 can remove or omit phone call outreach analytics system 104 from processing in one or more blocks of FIG. 4 and/or FIG. 5. Other examples are also possible.

Some implementations can store output data corresponding to the target patient, e.g., over time. In some implementations, based on such historical output data, the method can generate output data including a history of prior output data related to the target patient. For example, the output can be a display of a graphical representation or other representations.

The method 500 described above is just one representative implementation. The method blocks described herein can be performed by other entities in alternative implementations, in addition to or instead of the entities described for each block. For example, in block 506, patient actions can be identified by the analytics system 104 and outreach options can be identified by the facility system 102, or vice versa, etc.

In some alternate implementations, one or more prediction models can be defined or updated at least partially dynamically or in real-time in response to receiving a request for output for a target patient, e.g., in response to the request of block 502 in FIG. 5. In some examples, an existing prediction model (e.g., as described in FIG. 4) can be defined or updated. For example, any new relevant data obtained since the last update to the prediction model of the identified patient action and selected outreach option can be included in the update to one or more prediction models.

FIG. 6 is a flow diagram illustrating a method 600 including example blocks to perform operations of block 512 of FIG. 5. For example, operations of method 600 can determine an expected value of the selected outreach option for the identified patient action. In some examples, some or all of method 600 can be performed by the analytics system 104. Alternatively, some or all of method 600 can be performed by one or more facility systems 102 or other computing systems.

In some implementations, estimated valuations and expected value can be determined based on one or more particular goals of the patient and/or the healthcare facility. For example, a goal of the healthcare facility may be to evaluate outreach options in terms of maximizing an increase in the quality of life or health of the patient for a given cost to the healthcare facility. In another example, the healthcare facility may have a specific goal, e.g., reducing untreated diabetes by a certain amount (e.g., 20%). In such cases, an expected value can be determined based on such specific goals, e.g., whether the target patient's diabetes condition is expected to be reduced by the specific goal of the healthcare facility.

In block 602, the analytics system 104 identifies one or more estimated valuations for the selected outreach option and/or the identified patient action. The estimated valuations can be used in determining an expected value for the target patient and/or for the healthcare facility in implementing the selected outreach option, as described below.

For example, the system 104 can obtain a variety of estimated valuations of various patient actions, outreach options, and/or other functions or characteristics related to a goal of the healthcare facility. In some examples, a facility system 102 can provide one or more estimated valuations, and/or the analytics system 104 can determine one or more estimated valuations.

Estimated valuations can be defined in a variety of ways in different implementations, based on the goals of the patient and/or healthcare facility. For example, valuations can be based on a current health indicator indicative of a current health of the target patient, where a particular patient action can be estimated to provide a particular estimated value to the current health of the patient. In one example, a patient action of going to a doctor can have a high estimated valuation if the target patient currently has an ongoing infection treatable by the doctor (as determined from the patient's health profile). In contrast, the patient action of going to a doctor may have a low estimated valuation if the target patient currently has ongoing pain that is not immediately relieved by going to a doctor. An outreach option that reminds a patient to go to the doctor in these cases can similarly be assigned a high or low estimated valuation, respectively. The analytics system 104 (or facility system 102) can determine such estimated valuations based on current patient status or health profile, for example. Data can be determined, stored, and obtained that indicates the health benefits of a variety of different medically-related patient actions that lead to particular medical treatments, refer the patient to a particular doctor or specialist, etc.

Similarly, in some implementations the estimated valuation can be based on a future health indicator indicating a predicted future health of the target patient. For example, a patient action of going to a dietician at the healthcare facility can have a high estimated valuation if the target patient will benefit greatly from a new diet in months or years in the future. In contrast, the patient action of going to a dietician may have a low estimated valuation if the target patient already has a healthy diet. An outreach option that reminds a patient to go to the dietician in these cases can similarly have a high or low estimated valuation, respectively.

In some implementations, an estimated valuation can be based on one or more measures of a current quality of life of the target patient and a predicted future quality of life of the target patient. For example, numerical measures of wellness and quality of life of persons may be defined based on any of a number of factors, e.g., amount of pain experienced by a person, amount of mobility or paralysis, amount of dependence on nursing care, time spent receiving needed medical treatment, etc. A predicted future quality of life at particular future points in time can be measured similarly based on a predicted change in the person's condition. The measures may be time-weighted, e.g., having different weights at different times from the current time. Such numerical measures, and/or rules for determining such numerical measures, can be used to provide estimated valuations of patient actions and/or outreach options. For example, a patient action to see a doctor to receive a wheelchair can increase the mobility of the target patient and thus set a predicted future quality of life measure for the target patient to a higher value than a different treatment that does not increase the patient's mobility. The estimated valuation of the patient action can be set or adjusted to an amount based on the increase in quality of life measure. An outreach option to facilitate the user in seeing the doctor can be set or adjusted to a similar estimated valuation.

In some implementations, estimated valuations can be based on monetary costs related to patient actions and/or an outreach options. For example, an estimated valuation can be based on one or more action costs to implement the identified medically-related patient action. These can be costs to perform and/or respond to the identified medically-related patient action. For example, the action costs can be specified in monetary currency or in some other form of currency or value (spent time of patient and/or facility personnel, etc.). Action costs can include costs to the target patient to perform the action (e.g., costs to the patient for a doctor's visit), and/or can include costs to the healthcare facility to provide health care treatment in response to the patient action (e.g., the cost to the facility to reserve the time of the doctor for the patient, use medical equipment for patient treatment, etc.).

In some implementations, an estimated valuation can be based on one or more outreach costs to implement the selected outreach option. For example, the outreach costs can be specified in monetary currency or in some other form of currency or value. Outreach costs can include costs to the healthcare facility to implement the outreach option, e.g., the cost in time to the facility for healthcare personnel to implement the outreach option (e.g., send email, make a call, visit a house, etc.), the cost of a service (e.g., a mailing service), the cost in power and/or computing resources of facility systems 102 and/or analytics system 104 to send an electronic message for the outreach option, etc. In some cases, some action costs and/or outreach costs can be obtained from facility operating data.

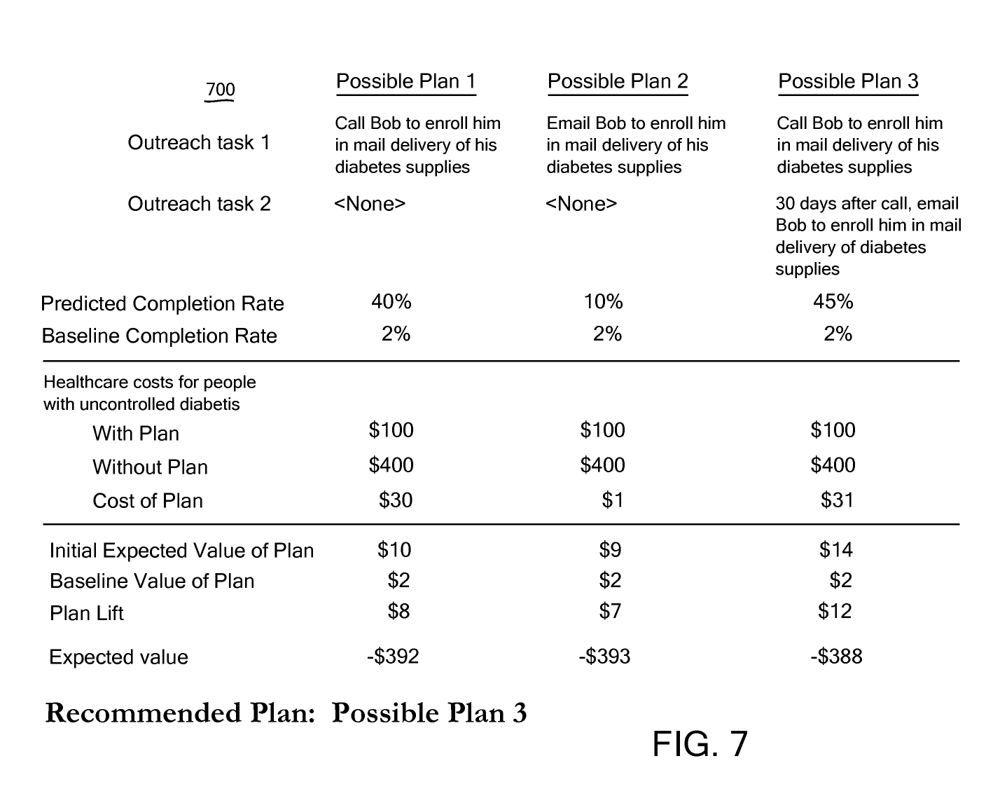

Some additional examples of estimated valuations are described below with respect to displayed information in the graphical user interface of FIG. 7.

In block 604, the method uses the baseline patient response metric and the estimated valuation of the identified patient action to obtain a baseline value. For example, the baseline patient response metric can be determined as a patient response metric in which no outreach option occurs, as described above with reference to FIG. 5. The baseline patient response metric indicates the probability that the target patient will perform the identified patient action in the absence of the selected outreach option. Block 604 can determine a baseline value related to that patient action. For example, the baseline patient response metric can be multiplied by the estimated valuation of the identified patient action to determine the baseline value. Alternatively or additionally, the baseline patient response metric can be otherwise modified by the estimated valuation (e.g., via addition, subtraction, or other operation(s)).

In block 606, the method uses the patient response metric and the estimated valuation of the identified patient action to obtain an initial expected value of the selected outreach option. For example, the patient response metric can be determined in block 510 of FIG. 5. The patient response metric may indicate a higher probability than the baseline patient response metric used in block 604 due to the selected outreach option being performed. Block 606 determines an initial expected value of the selected outreach option that does not take into account the baseline value. For example, in some implementations to determine the initial expected value, the patient response metric can be multiplied by the estimated valuation of the patient action, and/or modified by the estimated valuation of the outreach option, e.g., by subtraction or other operation.

In block 608, the method determines the expected value of the selected outreach option based on the initial expected value that is adjusted by the baseline value. For example, in some implementations the expected value of the outreach option can be determined by reducing the initial expected value by the baseline value. The baseline value indicates the value of the identified patient action in the absence of the outreach option, e.g., based on the probability of the target patient performing the identified patient action in the absence of the implementation of the outreach option. The expected value can be the initial expected value reduced by this baseline value. For example, this may more accurately reflect a value addition of the outreach option over the baseline condition.

In some implementations, the expected value can be determined or described in other ways. For example, as described for the example graphical user interface 700 of FIG. 7, a second expected value can be determined based on the (first) expected value determined in block 608. In one example, the second expected value can be determined as an estimated valuation of the identified patient action without implementing the selected outreach option, subtracted from the first expected value. For example, this can describe expected value of an outreach option in terms of estimated valuations.

In some implementations, an expected value can be determined for each individual effort or task included in an outreach option. In various implementations, a resulting expected value can be based on a combination of such individual expected values, e.g., a sum, average, mean, etc.

The blocks of the methods described herein need not be performed in the order described and can be performed in different orders or partially or completely simultaneously. For example, in method 500, multiple patient response metrics can be determined at least partly in parallel, e.g., with simultaneous or partially simultaneous performance of blocks 510 and 512 for multiple different outreach options and/or multiple different patient actions.

### Output Examples

FIG. 7 is a diagrammatic illustration of an example graphical user interface 700 that may be displayed by a facility system 108 (or other computing system). For example, the display can be in accordance with instructions from the analytics system 104.

The analytics system 104 and/or healthcare facility system 108 may be configured to facilitate causing one or more of the healthcare facility systems 108 to output various information regarding outreach options and patient actions, e.g., an indication of patient response metrics, expected values, and/or recommendation of outreach options to implement. These indications may take various forms.

The graphical user interface 700 is shown to include various information about outreach options and patient actions for a healthcare facility. In some implementations, the information shown can be displayed in response to a request from healthcare personnel (e.g., an operations manager in a healthcare facility) for a recommendation of outreach options for the healthcare facility to implement. The outreach options are intended to facilitate a target patient in performing a particular medically-related patient action. In this example, the manager has selected or otherwise input to a facility system 102 a name of a target patient, “Bob”. The manager wishes to see information that provides guidance as to which outreach options should be implemented to assist Bob to perform a medically-related patient action. In this example, the patient Bob has an uncontrolled diabetes medical condition. The healthcare facility has determined that Bob should perform a patient action of enrolling in mail delivery of diabetes-related supplies (e.g., blood sugar monitoring items, insulin shot items, etc.) to Bob's home to treat Bob's ongoing diabetes condition. The manager would like to view information indicating which outreach option(s) of the healthcare facility may be most effective in causing Bob to enroll in the mail delivery service.

In the example shown, the graphical user interface 700 may include a display of “possible plans” such as Possible Plan 1, Possible Plan 2, and Possible Plan 3. These plans each include a possible outreach option that the healthcare facility can perform. For example, Possible Plan 1 specifies an outreach option having an individual task of calling Bob to enroll him in mail delivery of supplies, Possible Plan 2 specifies an outreach option having an individual task of emailing Bob to enroll him, and Possible Plan 3 specifies an outreach option having the two individual tasks performed in sequence, including calling Bob and then emailing him.

Graphical user interface 700 also displays, for each possible plan, the patient response metric (e.g., “predicted completion rate”) and the baseline patient response metric (e.g., “baseline completion rate”) for the outreach option in that plan. These measures can be determined as described with respect to FIGS. 4 and 5.

Graphical user interface 700 also displays, for each possible plan, estimated valuations related to the medically-related patient action of enrolling in the mail delivery of diabetes-related supplies. In this example, the system has used an estimated valuation based on the monetary cost of health care for the patient if the patient is enrolled in the mail delivery. The system also has used an estimated valuation based on monetary cost of health care for the patient if the patient is not enrolled in the mail delivery. The estimated health care costs when the patient is enrolled in the mail delivery are less than the estimated health care costs when not enrolled. This may be because the automatically-mailed supplies provide continual ongoing health benefits to the patient such that the patient requires fewer doctor visits and other reduced health care treatment. This example also uses an estimated valuation of the cost to the healthcare facility of implementing the outreach option of each plan (“cost of plan”), which can include, for example, estimated costs of a mailing service, cost of systems that enable sending email, etc.

Graphical user interface 700 also displays, for each possible plan, the initial expected value of the plan and the baseline value of the plan. For example, these measures can be determined as described above with respect to FIG. 6. In this example, the initial expected value is determined by multiplying the patient response metric (predicted completion rate) with the cost of healthcare with the plan, and subtracting the cost of the plan. The baseline value is determined by multiplying the baseline patient response metric (baseline completion rate) with the cost of healthcare with the plan. In this example, the baseline assumes the patient has enrolled in the mail delivery without any outreach options being implemented, and thus there is zero value to the “cost of plan” to the healthcare facility.

The expected value of the plan can also be displayed in interface 700. In this example, the interface 700 displays a “plan lift” for each plan, as the difference between the initial expected value and the baseline value. This can be one form of expected value, showing how much the outreach options of the plan have increased the value over a situation in which no outreach options are implemented. In this example, the interface 700 can also display another form of expected value for each plan, shown as “expected value” in FIG. 7. This expected value is the healthcare cost without using the plan, subtracted from the plan lift. For example, the expected value of Possible Plan 1 is −$392, which indicates that the healthcare facility can expect to pay $392 to implement Possible Plan 1, instead of paying $400 (the healthcare cost without using the plan).

The graphical user interface 700 can also display one or more recommendations of a particular plan (e.g., recommendations of one or more outreach options) that the healthcare facility should implement. For example, the system can rank the expected values of the plans and can recommend the highest ranking plan. In this example, the graphical user interface 700 displays a recommendation of Possible Plan 3. This is based on ranking the expected values and selecting the highest ranking plan, where Possible Plan 3 will cost the healthcare facility the least amount ($388) compared to Possible Plan 2 ($393), Possible Plan 1 ($392), and no plan implemented ($400). Thus, the healthcare computing system has found that the most cost effective outreach option for the healthcare facility to implement, which also has the most effective patient completion rate, includes both task 1 and task 2.

In some implementations, the graphical user interface 700 may also include a selectable element for one or more displayed items (measures, outreach options, or other parameters) that, once selected by a user, may cause the graphical user interface 700 to display an indication of the data that contributed to the selected item. For example, the user can select a predicted completion rate value, causing a display (e.g., in a separate window) of data including descriptions of past occurrences of the target patient performing the patient action and other patient data and facility data used in the determination of that predicted completion rate value. In some implementations, the system can receive input from the user changing one or more of the displayed items to cause the system(s) to determine new output based on the changed items. For example, the user can select the healthcare costs with or without the plan and/or the cost of the plan to change these values, causing the system to determine new expected values based on the changes. In some implementations, the user can select a displayed patient response metric to view a description of data involved in determining that metric (e.g., patient data and/or healthcare facility operating data), and can change that data to cause a new patient response metric and expected value to be determined and displayed.

The graphical user interface 700 may display other information related to the outreach options, patient action, patient data, healthcare facility operating data, etc. Other displays and visualizations of information can be provided in other implementations. For example, the graphical user interface can display a graphical representation of patient response metrics and/or expected values over time, based on the historical data related to the target patient.

To the extent that examples described herein involve operations performed or initiated by actors, such as “humans”, “operators”, “users” or other entities, this is for purposes of example and explanation only. The claims should not be construed as requiring action by such actors unless explicitly recited in the claim language.

A number of implementations have been described. Features described with conditional language may describe implementations that are optional. The functional blocks, methods, devices, and systems described in the present disclosure may be integrated or divided into different combinations of systems, devices, and functional blocks as would be known to those skilled in the art. Although the description has been described with respect to particular implementations thereof, these particular implementations are merely illustrative, and not restrictive. Concepts illustrated in the examples may be applied to other examples and implementations. Thus, various modifications may be made without departing from the spirit and scope of this disclosure and the following claims.

1. A computing system comprising:
at least one processor;
a non-transitory computer-readable medium coupled to the processor; and
program instructions stored on the non-transitory computer-readable medium that are executable by the at least one processor to cause the computing system to:
identify a plurality of outreach options for causing a target patient to take a medically-related action;
based on patient data, determine a patient response metric for each of the plurality of outreach options for the medically-related patient action, wherein a patient response metric for a given outreach option indicates a probability that the patient will perform the medically-related patient action in response to the given outreach option;
generate output data based on the patient response metrics for the plurality of outreach options; and
transmit the output data to an output device, wherein the output data facilitates display, by the output device, of a representation of at least one of the plurality of outreach options.

2. The computing system of claim 1, wherein the program instructions are further executable by the at least one processor to cause the computing system to:
based on the patient response metrics, determine a prioritization for one or more of the plurality of outreach options; and
wherein the output data facilitates causing the output device to display a representation of the prioritization.

3. The computing system of claim 1, wherein the program instructions are further executable by the at least one processor to cause the computing system to:
facilitate the automatic execution of at least one outreach option of the plurality of outreach options.

4. The computing system of claim 3, wherein the program instructions are further executable by the at least one processor to cause the computing system to trigger at least one of:
an electronic message to be sent to the target patient;
a call to be placed to the target patient;
a letter to be generated and sent to the target patient via physical mail; or
a visit to the target patient to be scheduled.

5. The computing system of claim 1, wherein the program instructions are further executable by the at least one processor to cause the computing system to:
based on the patient response metrics and based on one or more estimated valuations assigned to the medically-related patient action, determine an expected value for each of the plurality of outreach options; and
wherein the generation of output data is based on at least one of the expected values.

6. The computing system of claim 5, wherein the program instructions are further executable by the at least one processor to cause the computing system to:
based on the patient data, determine a baseline patient response metric associated with each of the patient response metrics, wherein the baseline patient response metric indicates the probability that the patient will perform the medically-related patient action in absence of the outreach option associated with the patient response metric; and
wherein the determination of the expected value for each of the plurality of outreach options comprises adjustment of each expected value based on the corresponding baseline patient response metric.

7. The computing system of claim 5, wherein the estimated valuations are based on at least one of:
a current health indicator indicative of a current health of the target patient;
a future health indicator indicating a predicted future health of the target patient;
one or more measures of a current quality of life of the target patient and a predicted future quality of life of the target patient;
one or more action costs to implement the medically-related patient action; or
one or more outreach costs to implement one or more of the plurality of outreach options.

8. The computing system of claim 1, wherein the medically-related patient action is one of a plurality of identified medically-related patient actions and the plurality of outreach options comprise one or more outreach options associated with each of the plurality identified medically-related actions, and wherein determining patient response metrics comprises:
based on the patient data, determining the patient response metric for each of one or more combinations of one of the plurality of identified medically-related patient actions and one or more of the associated outreach options, wherein the patient response metric indicates the probability that the patient will perform the medically-related patient action of a given combination in response to the one or more associated outreach options of the given combination.

9. The computing system of claim 1, wherein a first outreach option of the plurality of outreach options comprises a first individual outreach effort and not a second individual outreach effort, and a second outreach option of the plurality of outreach options comprises both the first and second individual outreach efforts.

10. The computing system of claim 1, wherein the patient data comprises data describing a history of the target patient and wherein the patient response metrics are determined additionally based on the data describing the history, wherein the data describing the history comprises a financial history of the target patient.

11. The computing system of claim 1, wherein the patient data comprises data describing a history of the target patient and wherein the patient response metrics are determined additionally based on the data describing the history, wherein the data describing the history comprises a transaction history of the target patient with respect to the healthcare facility.

12. The computing system of claim 1, wherein the patient data comprises location data describing a geographic home location of the patient and distances from the geographic home location to one or more geographic locations of the healthcare facility, and wherein the patient response metrics are determined additionally based on the location data.

13. The computing system of claim 1, wherein the patient data comprises location history data describing a history of geographic locations visited by the target patient and a time and frequency of visits to the geographic locations by the target patient, and wherein the patient response metrics are determined additionally based on the location history data.

14. The computing system of claim 1, wherein the patient response metrics are determined based on one or more prediction models of patient response, wherein the one or more prediction models are based on historical data describing prior outreach options previously implemented and prior patient responses by at least one patient to the prior outreach options.

15. The computing system of claim 1, wherein the medically-related patient action comprises at least one of:
the target patient visiting the healthcare facility or other healthcare facility;
the target patient obtaining items of a medical prescription at a physical location visited by the target patient;
the target patient enlisting in a plan that reminds the target patient of medical treatment to receive; or
the target patient enlisting in a plan that sends one or more items of a medical prescription to the target patient.

16. A non-transitory computer readable medium having instructions stored thereon that are executable to cause a computing system to:
identify a plurality of outreach options for causing a target patient to take a medically-related action;
based on patient data, determine a patient response metric for each of the plurality of outreach options for the medically-related patient action, wherein a patient response metric for a given outreach option indicates a probability that the patient will perform the medically-related patient action in response to the given outreach option;
generate output data based on the patient response metrics for the plurality of outreach options; and
transmit the output data to an output device, wherein the output data facilitates display, by the output device, of a representation of at least one of the plurality of outreach options.

17. The non-transitory computer readable medium of claim 16, wherein the instructions further cause the computing system to trigger at least one of:
an electronic message to be sent to the target patient;
a call to be placed to the target patient;
a letter to be generated and sent to the target patient via physical mail; or
a visit the target patient to be scheduled.

18. The non-transitory computer readable medium of claim 16, wherein the instructions further cause the computing system to:
based on the patient response metrics and based on one or more estimated valuations assigned to the medically-related patient action, determine an expected value for each of the plurality of outreach options; and
wherein the generation of output data is based on at least one of the expected values.

19. A computer-implemented method comprising:
identifying a plurality of outreach options for causing a target patient to take a medically-related action;
based on patient data, determining a patient response metric for each of the plurality of outreach options for the medically-related patient action, wherein a given patient response metric for a given outreach option indicates a probability that the patient will perform the medically-related patient action in response to the given outreach option;
generating output data based on the patient response metrics for the plurality of outreach options; and
transmitting the output data to an output device, wherein the output data facilitates display, by the output device, of a representation of at least one of the plurality of outreach options.

20. The computer-implemented method of claim 19, further comprising:
based on the patient response metrics, determine a prioritization for at least one of the plurality of outreach options; and
wherein the output data facilitates display, by the output device, of a representation of the prioritization.
